(19) United States
(12) Patent Application Publication
(10) Pub. No.: US 2025/0130053 A1
(43) Pub. Date: Apr. 24, 2025

(54) DECOUPLED ELECTRIC VEHICLE ROUTING

(71) Applicant: Einride AB, Stockholm (SE)

(72) Inventor: Kleio FRAGKEDAKI, Stockholm (SE)

(73) Assignee: Einride AB, Stockholm (SE)

(21) Appl. No.: 18/903,983

(22) Filed: Oct. 1, 2024

Related U.S. Application Data
(60) Provisional application No. 63/591,892, filed on Oct. 20, 2023.

(51) Int. Cl. G01C 21/34; B60L 53/68

(52) U.S. Cl. CPC G01C 21/3446; B60L 53/68; G01C 21/3407; G01C 21/3476; B60L 2200/28; B60L 2200/36

(57) ABSTRACT

Systems and methods for routing rechargeable entities are described. A processor can receive input indicating a state of a charging network that includes charging stations, rechargeable entities and objects with assigned destinations. The processor can execute, for each object, a decision making process to model decision making by a reinforcement learning agent. The decision making can include applying a sequence of actions on the charging network to change states of the charging network. The processor can determine a sequence of states of the charging network based on results from application of the sequence of actions. The sequence of states can represent transitions of the rechargeable entities and the objects to complete delivery of the objects to the assigned destinations. The processor can generate routing data to direct the rechargeable entities to navigate among the charging stations and to be coupled with the objects according to the sequence of states.

### CROSS-REFERENCE TO RELATED APPLICATION

This application is based upon and claims the benefit under 35 U.S.C. 119 (e) of U.S. Patent Application No. 63/591,892, filed on Oct. 20, 2023, and titled “DECOUPLED ELECTRIC VEHICLE ROUTING”, the entire disclosure of which is incorporated herein by reference in its entirety.

### BACKGROUND

The present disclosure relates in general to methods and systems for electric vehicle routing. Particularly, methods and systems for optimizing electric vehicle routing for rechargeable portions of electric vehicles while non-rechargeable portions are decoupled from the rechargeable portions.

Travelling with electric vehicles (EVs) and/or hybrid electric vehicles (HEVs) can be time consuming due to the need for recharging of batteries. Despite an increase in the number of road side charge stations, travel times may still be impacted by a desire to be optimally routed to the most efficient, least expensive, and most readily available road side charging stations. A tractor-trailer includes a tractor unit and a trailer coupled together, and electric tractor-trailers include tractor units that are EVs or HEVs (“electric tractor”) installed with batteries. Electric tractor trailers typically make long trips and multiple charges may be needed for a single trip. To recharge the battery of an electric tractor-trailer, the electric tractor and the trailer may need to wait for the battery of the tractor unit to complete charging before proceeding to complete the trip.

### SUMMARY

In one embodiment, a computer-implemented method is generally described. The method can include receiving input data indicating a current state of a charging network that includes a set of charging stations, a set of rechargeable entities and a set of objects with assigned destinations. The method can further include executing, iteratively for each object among the set of objects, a decision making process to model decision making by a reinforcement learning (RL) agent. The decision making can include application of a sequence of actions on the charging network, and an application of each action among the sequence of actions changes a state of the charging network. The method can further include determining a sequence of states of the charging network based on results from application of the sequence of actions. The sequence of states can represent transitions of the set of rechargeable entities and the set of objects to complete delivery of the set of objects to the assigned destinations. The method can further include generating routing data to direct the set of rechargeable entities to navigate among the set of charging stations and to be coupled with the set of objects according to the sequence of states.

In one embodiment, a system is generally described. The system can include a memory configured to store parameters representing a reinforcement learning (RL) agent and a processor. The processor can be configured to receive input data indicating a current state of a charging network that includes a set of charging stations, a set of rechargeable entities and a set of objects with assigned destinations. The processor can be further configured to execute, iteratively for each object among the set of objects, a decision making process to model decision making by the RL agent. The decision making includes application of a sequence of actions on the charging network, and an application of each action among the sequence of actions changes a state of the charging network. The processor can be further configured to determine a sequence of states of the charging network based on results from application of the sequence of actions. The sequence of states represent transitions of the set of rechargeable entities and the set of objects to complete delivery of the set of objects to the assigned destinations. The processor can be further configured to generate routing data to direct the set of rechargeable entities to navigate among the set of charging stations and to be coupled with the set of objects according to the sequence of states.

In one embodiment, a computer-implemented method is generally described. The method can include receiving input data indicating a current state of a charging network that includes a set of charging stations, a set of rechargeable entities and a set of objects with assigned destinations. The method can further include executing, iteratively for each object among the set of objects, a decision making process to model decision making by a reinforcement learning (RL) agent. The decision making can include application of a sequence of actions on the charging network, and an application of each action among the sequence of actions changes a state of the charging network. The method can further include determining a sequence of states of the charging network based on results from application of the sequence of actions. The sequence of states can represent transitions of the set of rechargeable entities and the set of objects to complete delivery of the set of objects to the assigned destinations. The method can further include determining a cost associated with the sequence of states, wherein the cost is based on a distance traveled by the set of rechargeable entities under the sequence of states, a penalty that represents stagnation of the set of rechargeable entities, and a reward that encourages selection of less-utilized rechargeable entities and minimize time for delivery of the set of objects. The method can further include training the RL agent using the determined cost.

Advantageously, the systems and methods described herein can provide a machine learning model for determining optimized routes of decoupled electric tractors (e.g., electric tractor units decoupled from a trailer) within a network of charging stations while taking into account charging station locations and charging times for the electric tractors. The optimized routes can be provided to the electric tractors such that the electric tractors can navigate among different locations and/or charging stations in the network and trailers can be selected for coupling to the electric tractors without waiting for their originally coupled, or previously coupled, electric tractor to complete charging. According to the optimized routes, trailers and electric tractors can be swapped to optimize the delivery path and the delivery time of the trailers, and to optimize the battery charging efficiency of the tractors. Trailers that are decoupled from electric tractors can be moved to different tractors without a need to wait for the electric tractors to complete charging. By charging decoupled electric tractors and allowing decoupled trailers to move among different electric tractors without waiting for charging to be completed, charging-related delays can be reduced and utilization of electric tractor fleets can be optimized, thus improving logistics efficiency. The machine learning model described herein can be trained using reinforcement learning, which does not require training data. The machine learning model described herein can be trained as a reinforcement learning agent that learns to make decisions by interacting with a simulation or model of the network including the charging stations, the electric tractors, and the trailers. Further, the systems and methods described herein can improve conventional computerized systems for solving truck and trailer routing problems (TTRP) that do not take into account features such as charging station locations and charging times for the electric tractors in combination with consideration for trailers such as parameters of trailer delivery paths including location, path, distance, time, or the like. The utilization of these features for training the machine learning model disclosed herein can provide routes that are further optimized when compared to conventional systems for solving TTRP problems.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing an example system that can implement decoupled electric vehicle routing in one embodiment.

FIG. 2 is a diagram showing a reinforcement learning model that can be used for decoupled electric vehicle routing in one embodiment.

FIG. 3A is a diagram showing an example result from an implementation of decoupled electric vehicle routing in one embodiment.

FIG. 3B is a diagram showing example states of a model of decoupled electric vehicle routing in one embodiment.

FIG. 4 is a diagram showing an example policy network for decoupled electric vehicle routing in one embodiment.

FIG. 5 is a diagram showing pseudocode of a set of instructions that can be executed to implement for decoupled electric vehicle routing in one embodiment.

FIG. 6 is a diagram showing pseudocode of another set of instructions that can be executed to implement for decoupled electric vehicle routing in one embodiment.

FIG. 7 is a diagram showing an example graph instance that can be used for training a machine learning model for decoupled electric vehicle routing in one embodiment.

FIG. 8A is a diagram showing a performance parameter from example implementations of a machine learning model for decoupled electric vehicle routing in one embodiment.

FIG. 8B is a diagram showing another performance parameter from example implementations of a machine learning model for decoupled electric vehicle routing in one embodiment.

FIG. 8C is a diagram showing another performance parameter from example implementations of a machine learning model for decoupled electric vehicle routing in one embodiment.

FIG. 8D is a diagram showing another performance parameter from example implementations of a machine learning model for decoupled electric vehicle routing in one embodiment.

FIG. 9A is a diagram showing a comparison of the performance of a machine learning model with baseline performance for decoupled electric vehicle routing in one embodiment.

FIG. 9B is a diagram showing another comparison of the performance of a machine learning model with baseline performance for decoupled electric vehicle routing in one embodiment.

FIG. 9C is a diagram showing another comparison of the performance of a machine learning model with baseline performance for decoupled electric vehicle routing in one embodiment.

FIG. 10A is a diagram showing a set of solutions resulted from a baseline network for decoupled electric vehicle routing in one embodiment.

FIG. 10B is a diagram showing a set of solutions resulted from a policy network for decoupled electric vehicle routing in one embodiment.

FIG. 11A is a diagram showing embeddings of a graph instance for decoupled electric vehicle routing in one embodiment.

FIG. 11B is a diagram showing distance distributions of nodes in a graph instance for decoupled electric vehicle routing in one embodiment.

FIG. 11C is a diagram showing a QQ-plot of the distance distributions in FIG. 11B in one embodiment.

FIG. 12 is a diagram showing an example system that can utilize a machine learning model trained for decoupled electric vehicle routing in one embodiment.

FIG. 13 illustrates a flow diagram of a process to implement decoupled electric vehicle routing in one embodiment.

FIG. 14 illustrates a flow diagram of another process to implement decoupled electric vehicle routing in one embodiment.

### DETAILED DESCRIPTION

In the following description, numerous specific details are set forth, such as particular structures, components, model architectures, computing techniques (e.g., in the form of program code executable to perform computing algorithms), processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

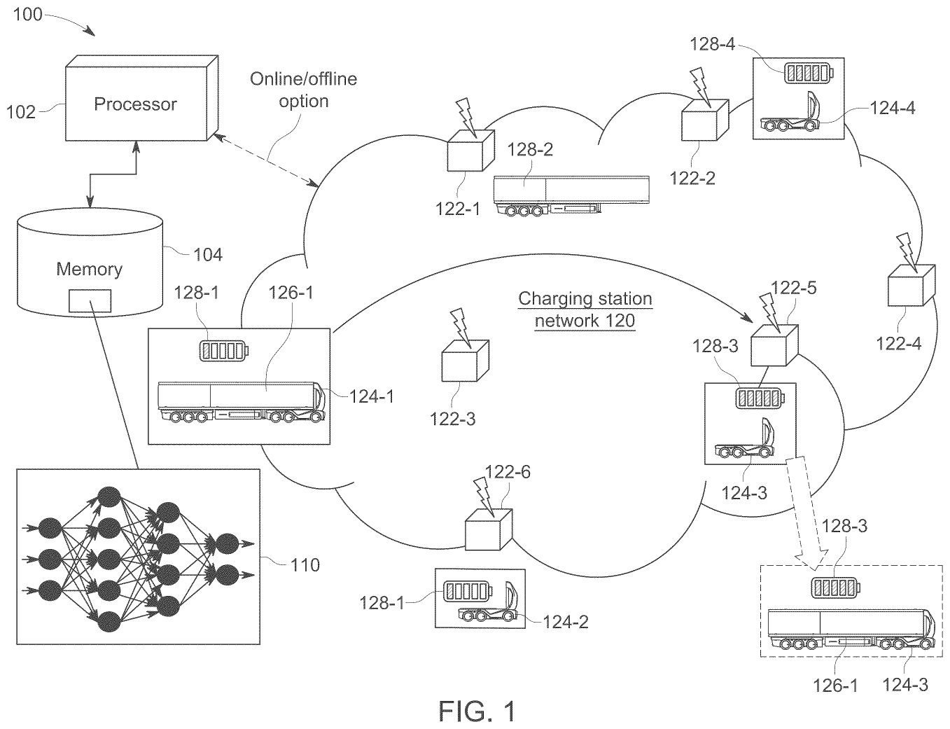

FIG. 1 is a diagram showing an example system that can implement decoupled electric vehicle routing in one embodiment. System 100 can include a processor 102, a memory 104, a charging station network 120. Processor 102 can be, for example, a microprocessor, a central processing unit (CPU) of a computing device, a single core processor, a multicore processor with multiple processor cores, a processor in a microcontroller, or other types of processors. Processor 102 can be configured to communicate with other devices using various input/output (I/O) controls and interfaces, network components and interfaces, communication buses of various protocols, or the like. Memory 104 can include one or more types of memory devices, including but not limited to volatile memory, non-volatile memory, registers, various types of read-only memory (ROM) and random-access memory (RAM), analog memory devices, or other types of memory.

Charging station network 120 can include a plurality of charging stations 122 located at physical locations spanning across a geographic area. In the example shown in FIG. 1, charging station network 120 can include six charging stations labeled as charging stations 122-1, 122-2, . . . , 122-6. Charging station network 120 can include an arbitrary number of charging stations. Each charging station 122 among charging station network 120 can include one or more battery chargers configured to charge batteries of electrical vehicles, such as a plurality of electric tractors 124. A number of electric tractors 124-1, 124-2, 124-3, 124-4 are shown in the example of FIG. 1. In one embodiment, electric tractors 124 can be among a predefined fleet of electric vehicles (EVs), where each electric tractor 124 can be coupled with a semi-trailer (“trailer”) 126. A number of trailers 126-1, 126-2, 126-3 are shown in the example of FIG. 1. In the present disclosure, electric tractors such as tractors 124 can be referred to as rechargeable entities and semi-trailers such as trailers 126 can be referred to as objects or non-chargeable entities.

In an aspect, conventional truck and trailer routing problems (TTRP) can use heuristic techniques to provide optimal routes for tractor-trailers to travel to destinations with minimum travelled distance. Conventional heuristic techniques for TTRP can take into account different driving speeds for trucks with and without trailers, accessibility to trucks with and without trailers, transfer of goods between trucks and trailers at designated locations, and location to swap goods. These conventional heuristic techniques for TTRP can be applied to electric tractors, but they do not take into account charging station locations and charging times for the electric tractors in combination with consideration for trailers such as parameters of trailer delivery paths including location, path, distance, time, or the like.

The methods and systems described herein can train a machine learning (ML) model 110 to determine optimized routes of decoupled electric tractors (e.g., electric tractor units decoupled from a trailer) within a network of charging stations, such as charging stations 122, while taking into account charging station locations and charging times for the electric tractors. Electric tractors can be assigned to different charging stations that are available and within a distance that can be reached by the electric tractors (e.g., reachable with remaining battery level of the electric tractors), and trailers can be selected for coupling to different electric tractors, without waiting for charging to be complete. Thus, trailers and tractors can be swapped to optimize the delivery path and the delivery time of the trailers, and the battery charging efficiency of the tractors. Trailers that are decoupled from electric tractors can be moved to different tractors without a need to wait for the electric tractors to complete charging. By charging decoupled electric tractors and allowing decoupled trailers to move among different electric tractors without waiting for charging to be completed, charging-related delays can be reduced and utilization of electric tractor fleets can be optimized, thus improving logistics efficiency. Further, the ML model 110 can be trained using reinforcement learning. Reinforcement learning does not require training data. The ML model 110 can be trained as a reinforcement learning agent that learns to make decisions by interacting with an environment. The agent, such as ML model 110, learns through trial and error and receives feedback in the form of rewards or penalties, and the goal is to maximize cumulative rewards over time.

In one embodiment, system 100 can be offline (e.g., processor 102 being disconnected from charging station network 120) such that processor 102 can run ML model 110 to simulate an optimal path for each one of tractors 124 to navigate to their respective destinations prior to the tractors 124 begin their delivery trips. In the offline mode, processor 102 can store simulation data of the optimal paths in memory 104 and also distribute the simulation data of optimal paths to computers in the tractors 124 to program the tractors 124 to navigate through the optimal paths during delivery. In another embodiment, system 100 can be online (e.g., processor 102 being connected to charging station network 120) such that processor 102 can run ML model 110 in real time to identify available tractors with sufficient battery level and/or available charging stations during delivery trips of tractors 124. Further, in the offline mode, processor 102 can function as a centralized reinforcement learning agent that makes decisions and optimizes the path for all tractors 124. In the online mode, computers of the tractors 124 can function as independent reinforcement learning agents to implement a multi-agent reinforcement learning scenario. Under the multi-agent reinforcement learning scenario, each computer in tractors 124 can function as an individual agent that makes autonomous decisions for its respective path based on the position of its own tractor and the other agents (e.g., computers in other tractors) and the trailers.

The following example can be applicable to an optimal path simulation in offline mode, or to real-time decision making in online mode. By way of example, the tractor 124-1 coupled with trailer 126-1 can enter charging network 120. At the time when tractor 124-1 enters charging network 120, a battery charging status 128-1 of tractor 124-1 can be at approximately 20%, which may be insufficient to deliver trailer 126-1 to its destination. Therefore, trailer 126-1 needs to be decoupled from tractor 124-1 and coupled to another tractor 124 that is available and has a battery charging status 128 sufficient to deliver trailer 126-1 to its destination. Processor 102 can run ML model 110 to identify a charging station to charge the battery of tractor 124-1 and identify a tractor 124 that can be coupled to trailer 126-1 to deliver trailer 126-1 to its destination. In the example shown in FIG. 1, a charging station 122-3 can be closest to the entering location of tractor 124-1 coupled to trailer 126-1, but no tractor is located at charging station 122-3. Charging station 122-6 can be the next closest to the entering location of tractor 124-1 coupled to trailer 126-1, but tractor 124-2 is being charged at charging station 122-6 and its battery is also insufficient to deliver trailer 126-1 to its destination. A tractor 124-3 can be fully charged at charging station 122-5, hence tractor 124-1 can move to charging station 122-5 and trailer 126-1 can be decoupled from tractor 124-1 and coupled to tractor 124-3. Tractor 124-1 can be charged at charging station 122-5 and tractor 124-3 coupled to trailer 126-1 can leave charging station network 120 to deliver trailer 126-1 to its destination. Therefore, trailer 126-1 can be delivered to its destination by tractor 124-3 instead of tractor 124-1 without a need to wait for tractor 124-1 to finish charging. Processor 102 can communicate with charging stations 122 tractors 124 to obtain various parameters, such as location data of charging stations 122 and tractors 124, and battery charging status 128 of the tractors 124. Processor 102 can use the obtained parameters to run ML model 110 and ML model 110 can generate an output that identifies one or more of a charging station and a tractor that can result in minimal travel time and distance to deliver a trailer to its destination.

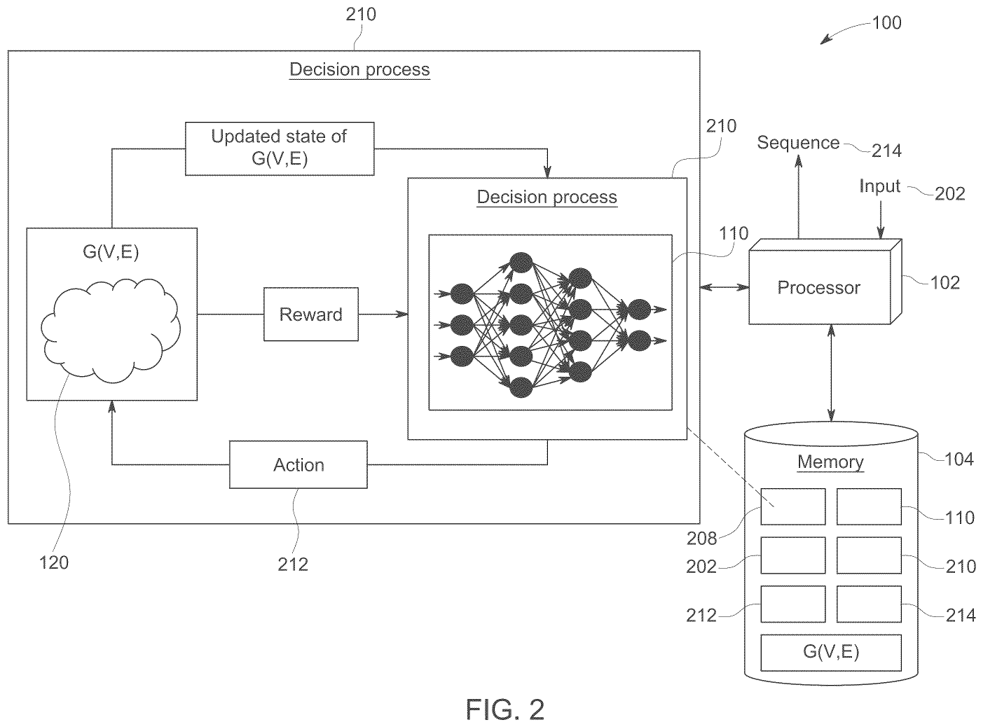

FIG. 2 is a diagram showing a reinforcement learning model that can be used for decoupled electric vehicle routing in one embodiment. Descriptions of FIG. 2 can reference components that are shown in FIG. 1. In an aspect, reinforcement learning (RL) can be defined by the Markov decision process (MDP). MDP is a modeling technique that models sequential decisions in discrete time steps (or decoding steps). In one embodiment, under the online mode, the RL environment can be defined by multi-model Markov decision process (MMDP). At every step, an RL agent takes an action includes a selection of a trailer, a tractor and a charging station (e.g., next charging station for the selected tractor to move to). The RL environment, or the MDP, takes the action and a current state, where the state is the location of the trailers, the location of the tractors, their battery levels, etc.) as the input. The RL environment, or the MDP, can grant a reward for the agent and the next state, where the next state is based on the action taken, such as new locations of the trailers, the tractors, their battery levels as a result of the action taken. Thus, a sequence of states, that represent each tractor and trailer locations and their battery levels at each discrete time step, can be generated as a solution. The solution can be an intermediate output for deriving a sequence of actions and the sequence of actions can be used for running ML model 110 to determine optimal paths for each tractor and/or trailer. The sequence of decisions and/or actions can be stored, such as in memory 104, and can be extracted by processor 102 to run ML model 110. In an aspect, a solution to ML model 110 can be a sequence of actions that provides optimal paths to deliver the trailers to their destinations. Through trial and error in navigating through the environment, the RL agent can build a set of rules or a set of policies. The policies can define how the RL agent decides which action to take next for an optimal cumulative reward. The RL agent can choose between further environment navigation to learn new policies.

The RL agent can be implemented by processor 102 and a ML model or an autonomous system, such as ML model 110 shown in FIG. 2, can implement an RL environment. In an aspect, an RL environment can be an adaptive problem space with attributes such as variables, boundary values, rules, and valid actions. In the examples shown and described herein, the RL environment being navigated by ML model 110 is a directed graph (or graph) G(V, E). An RL problem formulation can comprise of the RL environment (e.g., G(V, E)), RL actions, RL states, rewards and/or penalty. An RL state of the graph G(V, E) can be a state of the RL environment at a given point in time, including locations of trailers and tractors, and tractor battery levels, etc. An RL action “action 212”) can include selection of tractors, trailers and charging stations (e.g., next charging station), where the selections can be made by the RL agent, or ML model 110, to navigate the RL environment and change a state of the RL environment. A reward of the actions taken by ML model 110 can be positive, negative, or zero value, which will be described in more detail below along with descriptions of penalty. The RL problem formulation can be modified to enhance the results of the ML model 110, such as by changing the weight of the edges in the graph G(V, E) to capture the distances, road conditions, etc.

In one embodiment, charging station network 120 can include n charging stations 122 including charging stations 122-1, 122-2, . . . ,122-n. Hence, charging station network 120 can be modeled as the directed graph G(V, E), where Vis a set of n nodes Vi (i=0, . . . , n−1) representing the n charging stations 122. Each one of the n nodes (e.g., charging stations 122) can be represented by a time-dependent vector of attributes Nᵢ^{t}=(xᵢ, yᵢ, cᵢ, acᵢ^{t}, aeᵢ^{t}, asᵢ^{t}), where xᵢ and yᵢ are coordinates of the i-th node, cᵢ is the total number of chargers at the i-th node (or i-th charging station), acᵢ^{t} is a single boolean variable that indicates the availability of chargers at the i-th node during decoding step t, aeᵢ^{t} indicates whether at least one electric tractor (e.g., tractors 124) is present at the i-th node or not during decoding step t, and asᵢ^{t} indicates whether at least one semi-trailer (e.g., trailers 126) is present at the i-th node or not during decoding step t. E is a set of directed edges of the graph G, where E={(i, j, e, s, t): i,j∈V,i≠j}. The directed edges E are characterized by their starting node i and ending node j, the identity element e of the electric tractor in transit, the identity element s of the semi-trailer being transported (note that s=−1 if there is no semi-trailer present), and the decoding step t. The weight of each edge is represented by d_{i,j} is the Euclidean distance between the nodes i and j, which is equivalent to the travel distance from node i to node j. Overall, the graph G(V, E) models a network that includes n nodes, a fleet of m tractors, and k trailers that await delivery.

Processor 102 can receive a plurality of inputs 202 (“input 202” in FIG. 1), where each input 202 can be an instance problem for the RL problem formulation. In one embodiment, input 202 can be received from users of system 100 via a user interface being outputted by processor 102 on a display. In another embodiment, input 202 can be received from another processor, a device or a server connected to processor 102 via a communication network (e.g., Internet). Input 202 can indicate the parameters and variables that define V and E. Processor 102 can be configured to store the parameters and variables that define V and E for different problem instances (e.g., different input 202) in memory 104.

In one embodiment, the RL problem formulation including the graph G(V, E), the RL actions, the RL states, rewards and/or penalties, can be represented by a Markov decision process (MDP). Processor 102 can run and train ML model 110 based on a decision making process 210. Decision making process 210 can model decision making by ML model 110 as ML model 110 navigates graph G(V, E) taking an action 212 under discrete time steps (sometimes referred to as decoding steps herein). A set of instructions, such as executable code, of decision making process 210 can be stored in memory 104 and executable by processor 102. In an aspect, a decision by ML model 110 being modeled by decision making process 210 can form the action 212 that can change a state of G(V, E). Each action 212 can be represented by data encoding a vector of numeric values that specifies an operation for decision making process 210 to carry out on states of G(V, E). For example, the vector can represent tractors, trailers and next charging stations selected by decision making process 210 in action 212. Processor 102 can iteratively use decision making process 210 to iteratively form action 212 at different time steps actions and ML model 110 can take the different actions in graph G(V, E) at the different time steps, such as applying the different actions to modify or update a state of G(V, E) (e.g., one action is applied at a time). The state of G(V, E) can change in response to application of one action 212. Based on application of a sequence of actions at different time steps, processor 102 can generate a sequence 214 that can include a sequence of actions that were applied on G(V, E) and a sequence of states of G(V, E) that resulted from the application of the sequence of actions. The transition of states of G(V, E) based on the application of actions 212 models a behavior and decision making of tractors 124, trailers 126 and charging network 120.

In one embodiment, processor 102 can apply various constraints, objectives and/or conditions on the decision making process 210 to formulate a ML problem 208, where ML problem 208 can represent the RL problem formulation described above. By way of example, input 202 can indicate one or more constraints, objectives, and/or conditions that can optimize the solutions to formulate ML problem 208 for ML model 110. The formulation of the ML problem 208 can also include a setup of a reinforcement learning environment, such that the formulate ML problem 208 can include a reinforcement learning environment modeled by the one or more constraints, objectives, and/or conditions imposed on various components of the graph G(V, E). For example, the ML problem 208 can be encoded by a set of data stored in memory 104 that specifies a goal to determine optimized routes to deliver trailers to destinations with minimum travel distance and travel time. Processor 102 can be configured to write the parameter values defining these constraints, objectives, and/or conditions in memory 104. By way of example, input 202 can indicate location parameters for trailers 126 to define origin locations of trailers 126 and set destination parameters for trailers 126 such that each one of trailers 126 can be assigned to a destination. Model 110 can be trained under constraints and objectives (as indicated by input 202) such as ignoring the effect of payload on routing costs, assumption that the terrain travelled by the fleet is flat, equal travel speeds and energy consumption between charging stations 122, equal battery draining rate among tractors 124, or other constraints, objectives and/or conditions.

Further, model 110 can be trained under a condition that every time a tractor moves from one location to another location (e.g., from one charging station to another charging station), its battery is completely drained, making it unable to move to a next location. Similarly, model 110 can be trained under a condition that every time a tractor moves from one location to another location, its batter is depleted to a predetermined threshold, e.g. to 20% charged, so that the charge in the battery should not fall below the predetermined threshold under normal and/or expected operation. Under these conditions, a single timestep can be used for a tractor to fully recharge and become available again for the next location. The predetermined threshold can be static, e.g. 20% of capacity, or dynamic, for instance based on expected environmental conditions such as temperature, weather, road friction, wind, etc.

Furthermore, another constraint can be the travel distance of each tractor can be constrained by its battery capacity, which causes the tractor to access charging stations 122 or nodes in charging station network 120 located within a certain distance from its current position. ML model 110 can be trained to determine solutions to the ML problem 208 for different states of system 100, or states of G(V, E), such as optimal routes for tractors 124 such that all trailers 126 arrive at their respective destination while the total distance travelled by the fleet and the total travel time is minimized. The time duration in which tractors 124 are being charged at charging stations 122, and the selection of tractors 124 to be coupled to trailers 126, can impact the total distance travelled by the fleet and the total travel time.

With the decision making process 210 modeling decisions made by ML model 110 in graph G(V, E), at each decoding step t, a tractor 124 can move with or without a trailer 126. Due to the potential to revisit nodes, the ML model 110 can track in which decoding step a node was visited, which trailer was moved at the decoding step, and which tractor was used in order to construct a solution (e.g., sequence 214) to the decision making process 210. Within the decoding process at step t, the graph G(V, E) can capture states indicating node information and can incorporate two vectors including 1) the state of the electric tractors (e.g., tractors 124) is represented by ETₑ^{t}={nₑ^{t}, bₑ^{t}} and 2) the state of the semi-trailers (e.g., trailers 126) is represented by STₛ^{t}={nₛ^{t}, fₛ}. Each state in sequences 214 can include node information N^{t}, the tractors state ET^{t}, and the trailers state ST^{t}. In the example shown in FIG. 2, State(0) can be the state at decoding step or time t=0, State(1) can be the state at decoding step or time t=1 and State(2) can be the state at decoding step or time t=2.

Node information N^{t} can include information of a node or a charging station 122 at decoding step t, such as coordinates, the availability of chargers (e.g., represented by Boolean value), tractors and semi-trailers at the node, or other node information. The state ETₑ^{t} of an electric tractor e is a time-dependent vector that depends on the current location nₑ^{t} of the electric tractor e and the battery level bₑ^{t} at the beginning of decoding step t. The variable nₑ^{t} can correspond to the node (e.g., the charging station) where the electric tractor e is located at the beginning of decoding step t. Also, nₑ^{t} can be a m-dimensional vector denoting the current locations of m tractors and bₑ^{t} can be a m-dimensional vector representing the battery levels of the m tractors. The state STₛ^{t} of a trailer s is a time-dependent vector that depends on the current location nₛ^{t} of the trailer s and the final destination (e.g., assigned destination) fₛ of the trailer s. The variable nₛ^{t} can correspond to the node (e.g., the charging station) where the trailer s is located at the beginning of decoding step t. Also, nₛ^{t} can be a k-dimensional vector denoting location of k trailers at decoding step t and fₛ can be the m trailers' destinations. In one embodiment, during training, an initial condition of the ML problem 208 can set the value of b^{t} to 1, and each tractor and trailer can be randomly positioned at different nodes and the trailer's destination can be predefined or randomized. In one embodiment, during solution of a specific problem instance, an initial condition of the ML problem 208 can set the value of b^{t} to 1, and each tractor and trailer can be located in their actual positions or nodes and the trailer's destination can be set to, for example, charging station that is closest to the delivery destination.

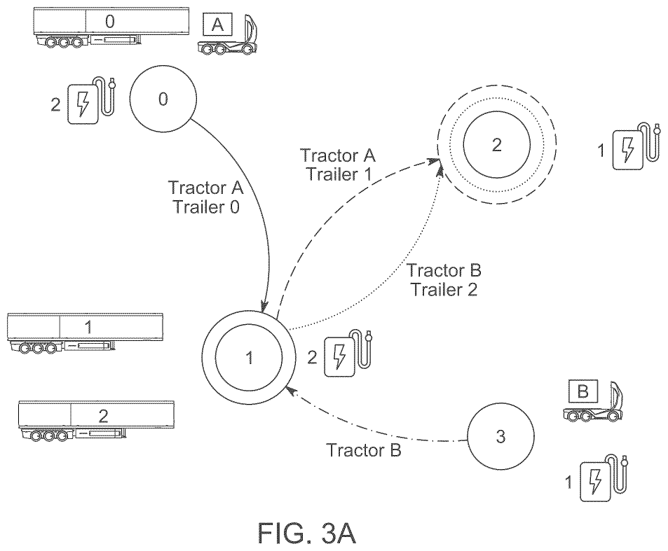

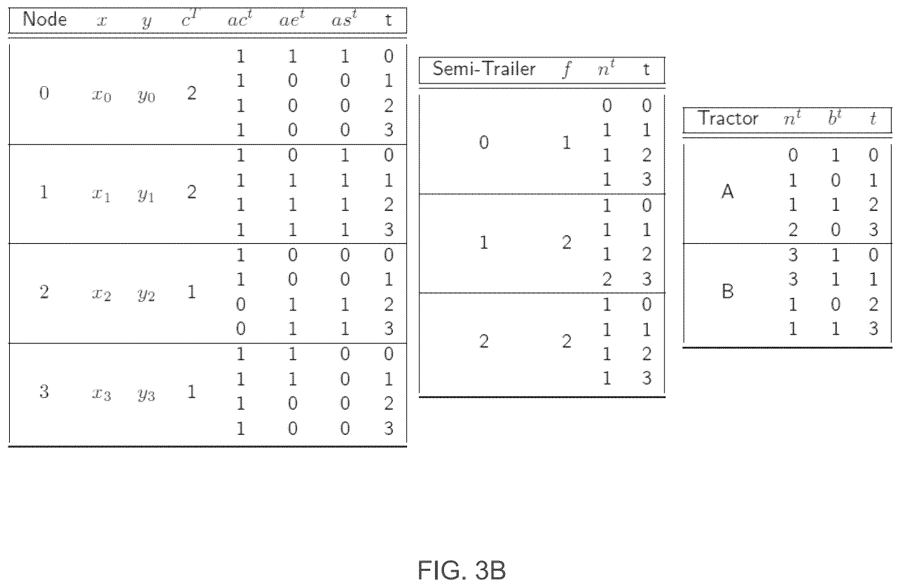

The solutions to the ML problem 208 can include sequences of actions, such as sequences 214. In one embodiment, sequences 214 can be a 5-tuples representing the starting node identifier (ID), the ending node ID, the electric tractor ID, the trailer ID and the decoding step t. The edges E in graph G(V, E) can be interpreted as the electric tractor routes. In an example shown in FIG. 3A, a graph of four nodes with two tractors with IDs A and B and three trailers with IDs 0, 1 and 2 are shown. For the example in FIG. 3A, an example solution sequence (e.g., sequences 214) is {(0, 1, A, 0, 0), (3, 1, B, −1, 1), (1, 2, A, 1, 2), (1, 2, B, 2, 3)}. This solution sequence can indicate that tractor A begins from its current node (node 0), moves to node 1 carrying semi-trailer 0 at decoding step t=0, charges for one step (step t=1), and then proceeds with semi-trailer 1 from node 1 to node 2 at decoding step t=2. Similarly, tractor B moves from its current location to node 3 at decoding step t=1, without transporting any semi-trailer, stays for one time step t=2 to recharge, and then moves to node 2 with semi-trailer 2 at decoding step t=3. Based on this solution, the state of the nodes, the electric tractors and trailers are changing respectively as shown in the tables in FIG. 3B. Note that the trailer ID can be ‘−1’ indicating non-co-location of the trailer and tractor.

The sequence 214 being outputted by processor 102 based on decision making process 210 can include a sequence of states of G(V, E) resulting from an application of a sequence of the actions on graph G(V, E). As shown in FIG. 2, Processor 102 can be configured to perform reinforcement learning to train ML model 110 using the actions taken by decision making process 210, and the sequence 214 including sequences of actions and states until specific termination conditions are satisfied. Processor 102 can, based on sequence 214, generate routing data that include instructions to direct tractors 124 to travel in charging network 120 to navigate to specific charging stations 122 for charging and/or to travel to pick up specific trailers 126 according to the routing data. In an aspect, processor 102 can run decision making process 210 can apply one action at a time on G(V, E) and the action being taken can be selected from a plurality of possible actions that may be encoded by data stored in memory 104. After each action, the state of G(V, E) can be updated and decision making process 210 can use the updated state to form a next action. By way of example, processor 102 can evaluate a reward of the updated state. In some aspects, the reinforcement learning can employ strategies where the balance of exploration (e.g., trying out new actions) and exploitation (e.g., using known best actions) is managed, which does not involve trying every possible action in every possible state, hence preserving computational power in complex environments with relatively large state and action spaces. The reinforcement learning performed by processor 102 can including learning a policy that progressively improves by interacting with the RL environment, where the learning includes updating the policy based on the outcomes of actions taken, guided by rewards, rather than exhaustive exploration of all possible actions.

By way of example, each action among actions 212 can be to append (e.g., decode) a 3-tuple (trailer ID, tractor ID, node ID), where node ID is a charging station ID, to the end of each one of sequences 214. The action at decoding step t is denoted as at and the resulting sequence up to step t as A^{t}. The notation aᵢ^{t} is to indicate the element of the 3-tuple, where the first element represents the selected trailer (e.g., a₀^{t} where i==0), the second element the selected tractor (e.g., a₁^{t} where i==1) and the last one the selected next node (e.g., a₂^{t} where i==2). The process terminates when all the trailers reach their destination node within an acceptable time frame

$$( {t}^{termination} = \frac{{n}^{k}}{m} )$$

under the assumption that the trailer arrives at its destination at step t^{l}, where t^{l}<t^{termination}. At each decoding step t, given N^{t}, ET^{t} and ST^{t}, the probability of selecting each trailer sⱼ to the sequence can be estimated as the probability distribution Pₛ(a₀^{t}=sⱼ|N^{t}, ET^{t}, ST^{t}), and decode the next trailer to pick, according to probability distribution Pₛ. Following, the probability of selecting each electric tractor eⱼ to the sequence can be estimated as the probability distribution Pₑ(a₁^{t}=eⱼ|N^{t}, ET^{t}, a₀^{t+1}), and based on that the next tractor to move is decoded. Further, the probability of selecting each node i to the sequence can be estimated as the probability distribution Pᵢ(a₂^{t}=i|N^{t}, a₀^{t+1}, a₁^{t+1}), and accordingly decode the next node to visit. Based on the a^{t}, the state using a plurality of transition functions (described below) can be determined.

Transitions between states, from state(t) to state(t+1), are determined based on the executed action a^{t}. A transition function of the elements ET^{t} can be expressed as follows, where the location of the tractor e is updated with the selected node if valid:

$${n}_{e}^{t + 1} = \{ \begin{matrix}{a}_{2}^{t} , if e = {a}_{1}^{t} and e \neq - 1 \\ {n}_{e}^{t} , otherwise\end{matrix} \qquad ( 1 )$$

A transition function of the battery level b^{t} is expressed as follows, where the battery level is set to zero if the tractor e selected is valid and the tractor e has moved to another location, otherwise, the tractor's battery is set to fully charged:

$${b}_{e}^{t + 1} = \{ \begin{matrix}0 , if e = {a}_{1}^{t + 1} and e \neq - 1 and {n}_{e}^{t} \neq {a}_{2}^{t} \\ 1 , otherwise\end{matrix} \qquad ( 2 )$$

Note that besides being encoded as binary values, the battery level b^{t} can also be encoded as parameters that vary with time and/or distance, such as the time and distance of travel that can reduce battery level.

A transition function of the element ST^{t} is expressed as follows, where the location of the selected trailer s is updated with the selected node, provided that the selection is valid, and the trailer s and the selected tractor e are at the same location:

$${n}_{s}^{t + 1} = \{ \begin{matrix}{a}_{2}^{t} , if s = {a}_{0}^{t} and s \neq - 1 and {n}_{s}^{t} = {n}_{e}^{t} , where e = {a}_{1}^{t} \\ {n}_{s}^{t} , otherwise\end{matrix} \qquad ( 3 )$$

Note that trailer s cannot be moved without a tractor e.

A transition function of the elements of N^{t}, for each node i∈V, can be expressed as follows, where the availability of chargers at the selected node is set to 0 if the total number of chargers minus one is less or equal to 0:

$$a {c}_{i}^{t + 1} = \{ \begin{matrix}0 , if {c}_{i} - 1 \leq 0 and i = {a}_{2}^{t} \\ 1 , otherwise\end{matrix} \qquad ( 4 )$$

A transition function for tractors availability aₑ^{t} is expressed as follows, where tractors availability is set to 0 if the location of at least one tractor does not match with the node ID:

$$a {e}_{i}^{t + 1} = \{ \begin{matrix}0 , {n}_{e}^{t + 1} \neq i : ∀ e ∈ E {T}^{t + 1} \\ 1 , otherwise\end{matrix} \qquad ( 5 )$$

A transition function for trailers availability as^{t} is expressed as follows, where the trailers availability is set to 0 if the location of at least one trailer does not match with the node ID:

$$a {s}_{i}^{t + 1} = \{ \begin{matrix}0 , {n}_{s}^{t + 1} \neq i : ∀ s ∈ S {T}^{t + 1} \\ 1 , otherwise\end{matrix} \qquad ( 6 )$$

In the context of the ML problem 208, one of the objectives is to deliver all trailers to their respective destination while minimizing the total distance traversed by the fleet. Given this objective, a cost function cost^{t+1} as an aggregation of three different components can be determined by:

$${cost}^{t + 1} = {distance}^{t + 1} + {penalty}^{t + 1} - {reward}^{t + 1} \qquad ( 7 )$$

The component distance^{t+1} is the total Euclidean distance, which is the cumulative Euclidean distance traveled by the fleet of m tractors, and distance^{t+1} can be expressed as:

$${distance}^{t + 1} = {\sum }_{e = 1}^{m} {\sum }_{t = 0}^{{t}_{l}} d ( {n}_{e}^{t} , {n}_{e}^{t + 1} ) , where {t}_{l} \leq \frac{{n}^{k}}{m} \qquad ( 8 )$$

The component penalty^{t+1} is the penalty for stagnation, such as a penalty when the selected tractor remains stationary at its current location, despite that the chosen trailer needs to be delivered. Accounting for this penalty stagnation can discourage the model G(V, E) from getting stuck in the same state, driving it towards fulfilling its objective. In one embodiment, a boundary surrounding a node or a charging station can be set by defining a threshold, or a threshold distance, from the node. If the selected tractor is within a specific tolerance value from the threshold after transiting from t to ^{t+1}, then the selected tractor can be considered as stagnant. For example, the threshold can be 0.6 distance units from a node, and a selected tractor remaining within a tolerance ±0.1 from the 0.6 distance unit (e.g., remaining within or less than 0.5 to 0.7 from t to ^{t+1}) can be considered as stagnant. In one embodiment, distances between nodes in directed graph G(V, E) (e.g., charging stations) can be restricted to a condition where each node is accessible from an electric tractor by at least one of the other nodes in the network. For example, the nodes can have a Euclidean distance of 0.6+/−0.1 distance units. Based on this restriction, the penalty can be defined as the least distance between two nodes in the networks, which results in a “least” possible penalty when a tractor is not moving, yet can be significant enough to avoid this action. The tolerance is set for the benefit of remaining at the same node under specific circumstances, such as awaiting the completion of another tractor's charging cycle. Overall, the penalty can be expressed as:

$${penalty}^{t + 1} = \{ \begin{matrix}threshold - 0.1 , if {t}_{l} \leq \frac{{n}^{k}}{m} \\ 0 , otherwise\end{matrix} \qquad ( 9 )$$

The component reward^{t+1} can be a reward for objective achievement, such as a reward given upon the successful delivery of a selected trailer to its destination. The reward component can be an incentive that promotes decisions that aligned with the objective and encourages the selection of less-utilized tractors. Additionally, the reward component can incorporate a time factor to favor time-efficient choices. The reward component can be expressed as:

$${reward}^{t + 1} = \{ \begin{matrix}\frac{1}{length [ {a}_{1}^{t} + t ]} , if {n}_{s}^{t + 1} = {f}_{s} and t \leq {t}_{l} and s = {a}_{0}^{t} \\ 0 , otherwise\end{matrix} \qquad ( 10 )$$

Further, under the reinforcement learning performed by processor 102 to train ML model 110, a reinforcement learning reward function r^{t+1} is formulated as the negative counterpart of the cost function, such as:

$${r}^{t + 1} = - {cost}^{t + 1} \qquad ( 11 )$$

As processor 102 runs decision making process 210 to model decision making by ML model 110 in G(V, E) to generate states in sequences 214, the distance, penalty, and reward functions (expressions (8), (9), (10)) of each sequence can be determined by processor 102. Processor 102 can determine the cost (expression (7)) using the determined distance, penalty and reward. Processor 102 can train ML model 110 based on the determined reward, which is the opposite of the cost as shown in expression (11) above. By way of example, a relatively low cost of a sequence can encourage ML model 110 to make decisions to achieve the same sequence that is already known to the ML model 110. A relatively high cost of a sequence can cause ML model 110 to make decisions to further navigate G(V, E) to identify new rules or policies that can result in another sequence having lower cost.

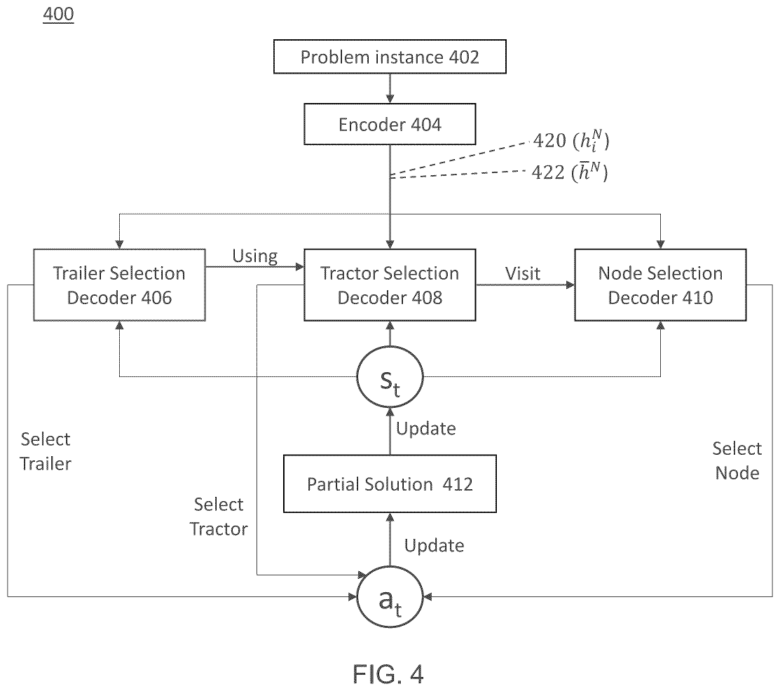

FIG. 4 is a diagram showing an example architecture for decoupled electric vehicle routing in one embodiment. Descriptions of FIG. 4 can reference components shown in FIG. 1 to FIG. 3. In one embodiment, ML model 110 can be an attention based deep neural network that enables the selection of trailers, tractors and nodes at each decoding step t. Decision making process 210 can cause ML model 110 to make different selections based on the actions 212 issued to graph G(V, E). An architecture 400 that can define a policy network being learned and trained by ML model 110 is shown in FIG. 4. Architecture 400 of ML model 110 can include one encoder 404 and three decoders including a trailer selection decoder 406 (“decoder 406”), a tractor selection decoder 408 (“decoder 408”) and a node selection decoder 410 (“decoder 410”).

Encoder 404 and decoders 406, 408, 410 can be implemented by hardware such as integrated circuits (ICs) that can be part of processor 102, software or a combination of hardware and software. Encoder 404 can be configured to receive a problem instance 402 as input (e.g., problem instance 402 can be same as input 202 in FIG. 2). Problem instance 402 can be an instance of graph G(V, E) that includes an example state of G(V, E), including randomly chosen raw data such as node coordinates (e.g., charging station location), availability status (e.g., boolean indicators) of chargers, tractors, and trailers per node. In an aspect, the example shown in FIG. 3A can be an example of problem instance 402 that includes a set of 3 trailers (trailer ID 0, 1, 2), 2 tractors (tractor ID A, B) and 4 nodes (node ID 0, 1, 2, 3). In one embodiment, processor 102 can train the ML model 110 and the set of trailers, tractors and nodes can be randomly chosen by processor 102 to generate problem instance 402. In another embodiment, when processor 102 runs ML model 110 in real-time, the set of trailers, tractors and nodes can be determined by processor 102 based on a state of charging network 120 received by processor 102. In one embodiment, encoder 404 can be used for encoding (e.g., reveal) information of raw data in problem instance 402. For example, if encoder 404 is a transformer encoder, encoder 404 can cause each node (e.g., charging station) to incorporate information about its neighbors such that decision making process 210 may select the next charging station for charging a tractor based on the known neighbor node information. In one embodiment, prior to data being provided to encoder 404, the dimensionality of the raw data can be expanded, such as to five dimensions or up to 128 dimensions, using linear propagation to allow encoder 404 to encode additional details.

Since ML model 110 can be an attention based deep neural network, encoder 404 can convert the raw data in problem instance 402 by processing the raw data through attention layers to extract specific features. The feature extraction through the attention layers can cause encoder 404 to generate node embeddings 420 and a graph embedding 422 that serves as input to the decoders 406, 408, 410. The node embeddings 420 can be vector representations of the nodes, or charging stations, in G(V, E). The node embeddings 420 can capture the structural and semantic information of the nodes (e.g., characteristics or attributes of the charging stations such as capacity, type of chargers available) and their relationships within the graph G(V, E). In an aspect, the node embeddings 420 can map each node in the graph G(V, E) to a dense vector in a continuous vector space, and similar nodes can be represented by similar vectors. Thus, computation of node similarities, clustering, and downstream tasks such as node classification, link prediction, and recommendation can be performed using the node embeddings 420. The graph embedding 422 can be a representation of the graph G(V, E) as a fixed-length vector in a continuous vector space (e.g., same continuous vector space as the node embeddings 420). Unlike the node embeddings 420 which represent individual nodes, the graph embedding 422 can capture the global structure and properties of the entire graph G(V, E). For instance, the graph embedding 422 can be the mean of all the node embeddings and can encode the topology, node attributes, and other relevant information of the graph G(V, E) into a vector representation that can have up to, for example, 128 dimensions, and the graph embedding 422 can be used for various tasks such as graph classification, graph clustering, and graph similarity computation.

The decoders 406, 408, 410 can use the node embeddings 420 and graph embedding 422 to generate sequence of actions including the 5-tuple that has the tractor's origin, the selected node, the chosen tractor, the chosen semi-trailer, and the decoding step. For a specific problem instance, processor 102 can run decoders 406, 408, 410 repeatedly until a termination condition, such as all trailers being delivered to their destinations, are met. The repeated operations of decoders 406, 408, 410 can cause a solution, which can include a sequence of actions taken on G(V, E), to be generated for the specific problem instance. When a new problem instance is provided to processor 102, processor 102 can run encoder 404 on the new problem instance and also run decoders 406, 408, 410 repeatedly again to generate a solution for the new problem instance. Encoder 404 can generate the node embeddings 420 and graph embedding 422 once and decoders 406, 408, 410 can reuse the node embeddings 420 and graph embedding 422 for generating a solution for the problem instance 402, thus providing enhanced computational efficiency. In one embodiment, the node embeddings 420 can be updated as the state is updated. Initially, the node embeddings 420 can include information such as whether the nodes have a tractor, whether the nodes have a trailer, whether the chargers at the nodes are available and location of the nodes. As the solutions, or sequence of actions, are being constructed, information such as the location of the trailers and tractors, availability of chargers, may also change. The changes to the information in the initial node embeddings 420 can impact the decisions to select nodes and trailers and to determine movement of the tractors. Hence, the node embeddings 420 can be updated as the state of G(V, E) is being updated. In one embodiment, processor 102 can run encoder 404 to update the node embeddings 420 during the generation of a solution for a problem instance such that encoder 404 and decoders 406, 408 410 can be run multiple times until the solution is constructed.

Processor 102 can operate decoders 406, 408, 410 to perform an iterative process that iteratively execute decision making process 210 to model decision making by ML model 110 in response to receiving actions that can be indicated in instance 402. The selections made by decoders 406, 408, 410 can be a result of processor 102 executing decision making process 210. In the iterative process, decoder 406 can first select a trailer using the encoded node embeddings of nodes where trailers are currently located. Next, decoder 408 can identify a suitable tractor for the selected trailer based on the encoded node embedding of the selected trailer and the state of tractors. Then, decoder 410 can determine the node to be visited by the selected trailer-tractor pair at each route construction step, which depend on both the state of trailers and tractors, and the node embeddings. The combination of the selected trailer, tractor and node forms an action for the decoding step t, which is subsequently used to update the states of graph G(V, E). This iterative process can continue until all trailers have been delivered to their destination, enabling the progressive construction of optimal routes that can be outputted as a sequence of states. The architecture 400 can allow decision making process 210 to make effective decisions from a global perspective and navigate the RL agent (e.g., ML model 110) in the RL environment (e.g., graph G(V, E) optimally by enabling swapping strategies.

By way of example, problem instance 402 can include 5 charging stations (e.g., 5 nodes), 2 tractors and 3 trailers. Node embeddings 420 can be a dₕ-dimensional vector with dₕ=128. Problem instance 402 can include a dₓ-dimensional attribute vector xᵢ for each node i. Encoder 404 can transform the attribute vector x; into the dₕ-dimensional vector node embeddings ho. Encoder 404 can perform this transformation through a linear projection with learnable parameters W^{x} and b^{x} as follows:

$${h}_{1}^{( 0 )} = {W}^{x} {x}_{i} + {b}^{x} \qquad ( 12 )$$

where W^{x} is a dₕ×dₓ=128×5 matrix, xᵢ is the attribute vector (e.g., a column matrix) for node i and b^{x} is a de-dimensional bias column vector. Node embeddings 420 can be iteratively updated across N attention layers, where each one of the N layers is composed of a pair of sublayers. In one embodiment, node embeddings 420 can be denoted as hᵢ^{l}, where l is an l-th attention layer among N attention layers of ML model 110 (e.g., l∈1, . . . , N). When the final layer is reached (e.g., l=N), encoder 404 can determine an aggregated embedding, which is graph embedding 422, denoted as h^{N}, of the input graph. The graph embedding 422 can be an average of the final node embeddings hᵢ^{N}, such as:

$${\overline{h}}^{N} = \frac{1}{n} {\sum }_{i = 1}^{n} {h}_{i}^{N} \qquad ( 13 )$$

As noted above, each attention layer among the N attention layers can include two sublayers. The two sublayers can include a multi-head attention (MHA) sublayer for propagating information across the graph G(V, E) and a fully connected feed-forward (FF) sublayer. Both sublayers can incorporate a skip-connection and batch normalization (BN), yielding the following expressions:

$${h}_{i}^{′ l} = B {N}^{l} ( {h}_{i}^{( l - 1 )} + M H {A}_{i}^{l} ( {h}_{i}^{( l - 1 )} , … , {h}_{n}^{( l - 1 )} ) ) \qquad ( 14 )$$

$${h}_{i}^{l} = B {N}^{( l )} ( {h}_{i}^{′ ( l )} + {FF}^{( l )} ( {h}_{i}^{′ ( l )} ) ) \qquad ( 15 )$$

The FF sublayer can operate as a node-wise projection leveraging a hidden sub-sublayer with a dimensionality of, for example, 512 and a ReLu activation. The MHA sublayer can employ a self-attention network with eight heads (M=8), where each head has a dimensionality of

$$\frac{{d}_{h}}{M} = \frac{128}{8} = 16.$$

The attention mechanism employed by ML model 110 can be interpreted as a weighted message-passing system, where each node receives messages from its neighboring nodes and the weight of the message depends on the compatibility of the node's query with the neighbor's key. Leveraging the MHA technique, nodes can process diverse message types from different neighbors. By way of example, a node embedding hᵢ of node i can be projected into a key kᵢ, a value vᵢ and a query qᵢ space, with learnable parameters W^{Q}, W^{K} and W^{V} as outlined below:

$${q}_{i} = {W}^{Q} {h}_{i} , {k}_{i} = {W}^{K} {h}_{i} , {v}_{i} = {W}^{V} {h}_{i} \qquad ( 16 )$$

The parameters W^{Q}, W^{K} and W^{V} are defined as 8×128×16 matrices, representing the eight-headed self-attention mechanism with each head (M=8) having a dimension of

$$\frac{{d}_{h}}{M} = \frac{128}{8} = 16 .$$

From the queries and keys, encoder 404 can determine the compatibility cᵢⱼ of the query qᵢ of node i with the key kⱼ of node j as their scaled dot-product. The compatibility of non-adjacent nodes can be −∞ to prevent message passing between these nodes:

$${c}_{i j} = \{ \begin{matrix}\frac{{q}_{i}^{T} {k}_{j}}{\sqrt{{d}_{k}}} , if i adjacent to j \\ - ∞ , otherwise\end{matrix} \qquad ( 17 )$$

From the compatibilities cᵢⱼ, encoder 404 can determine a set of attention weights aᵢⱼ using the function:

$${a}_{i j} = \frac{{e}^{{c}_{i j}}}{{\sum }_{k} {e}^{{c}_{i k}}} \qquad ( 18 )$$

Further, each node i can receives a weighted sum of messages, where each message being a vector vⱼ. Encoder 404 can concatenate and project the M heads into a new feature space with the same dimensionality as the original input hᵢ, such as:

$${h}_{i}^{′} = {\sum }_{j} {a}_{i j} {v}_{j} \qquad ( 19 )$$

Decoders 406, 408, 410 can transform the node embeddings 420 and graph embedding 422 into sequence of states (that is included in sequence 214), according to decision making process 210. The decoders 406, 408, 410 can operate iteratively, producing actions one at a time, and utilize the node embeddings 420 and graph embedding 422 along with a problem specific context. The decoders 406, 408, 410 can determine the visitation sequence of nodes and the movement strategies of both the tractors 124 and trailers 126. The movement strategies can include, but not limited to, delivering or picking up a trailer depending on the current locations of the selected semi-trailer and tractor.

Decoder 406 can determine which trailer is to be selected for delivery at a specific step. To perform this selection, decoder 406 can start by constructing a trailer feature context. The trailer feature context can include the node embeddings 420 of all trailers, augmented by an additional parameter indicating whether at least one charged tractor is available at the node i. This results in a context dimension of dₕ+1 (e.g., 128+1=129), where dₕ accounts for the node embedding 420 and the additional dimension accounts for the tractor availability. Decoder 406 can concatenate the trailer feature context and linearly projected it into a dₕ-dimensional space. The resulting context can be a higher-dimensional vector and can be further processed by a 512-dimension feed-forward layer, incorporating a ReLU activation function. By way of example, when where are 3 trailers, each trailer can correspond go 129-dimensions and the concatenation can result in 387-dimensions, and then project down from 387-dimensions to 128-dimensions. This sequence of operations can cause decoder 406 to generate a trailer feature embedding Ht. Based on the concatenated trailer feature embedding H_{S}^{t}, decoder 406 can determine a trailer selection probability vector, p^{t}. Decoder 406 can perform a linear propagation of the trailer feature context into k dimensions, where k is the total number of trailers within the problem instance 402. Trailers that have reached their destination are masked and thereby excluded from selection. Decoder 406 can apply a softmax activation function to the masked vector, yielding a probability distribution among trailers. Each element, pᵢ^{t}, represents the likelihood of selecting a trailer i at time step t. The selection strategy could be either greedy, picking the trailer with the maximum probability, or stochastic, sampling according to the vector pt. The chosen trailer is then used as input to decoders 408, 410. In some embodiments, in addition to using feed-forward networks as described above, other approaches such as attention sublayer can be used for implementing decoder 406. Further, trailer feature extractions can be implemented using various techniques and such that more information apart from the available chargers can be added in addition to data that area already available in the node embeddings.

Decoder 408 can assign a tractor to the selected trailer from decoder 406. Decoder 408 can output a probability distribution over potential tractors by using two embeddings including the tractor feature embedding and the trailer feature embedding. The tractor feature embedding can encapsulate the state of each tractor at the current decoding step t. Decoder 406 can determine a context C_{E}^{t} that includes the current location, and the battery level of each tractor at step t−1. The context C_{E}^{t} can be expressed as:

$${C}_{E}^{t} = [ {x}_{1}^{t - 1} , {y}_{1}^{t - 1} , {b}_{1}^{t - 1} , … , {x}_{m}^{t - 1} , {y}_{m}^{t - 1} , {b}_{m}^{t - 1} ] \qquad ( 20 )$$

Decoder 408 can project the context C_{E}^{t} linearly into a dₕ-dimensional space and further processed by a feed-forward layer with a dimensionality of 512 and a ReLU activation function, to generate the tractor feature embedding HE. The trailer feature embedding, denoted as H_{S}^{t}, corresponds to the node embedding where the selected trailer is situated at the current step. The node embedding is employed to efficiently represent the status of the trailer chosen from the preceding step. This representation captures information about both the state of the semi-trailer and its surrounding neighborhood in the graph.

Decoder 408 can concatenate the tractor and trailer feature embeddings and linearly projected the concatenated embedding into an m-dimensional feature space, where m corresponds to the total number of tractors in the fleet. Tractors deemed unavailable due to insufficient battery capacity can be masked, and a softmax activation function is applied to compute the probability of selecting each tractor as follows:

$${H}^{t} = W [ {H}_{E}^{t} , {H}_{S}^{t} ] + b \qquad ( 21 )$$

$${p}^{t} = \frac{{e}^{{H}^{t}}}{{\sum }_{{t}^{′}} {e}^{{H}^{{t}^{′}}}} \qquad ( 22 )$$

Each element pᵢ^{t} represents the probability of selecting tractor i at step t. Decoder 408 can select the tractor by retrieving the one with the maximum probability (greedy strategy) or sampling according to the probability vector p^{t}. The selected tractor and semi-trailer are then used as input to the node selection decoder 410.

Decoder 410 can utilize a context-based attention mechanism to determine the visiting probability of each node, thereby determining the next node to be visited by the chosen tractor from decoder 408. The input to decoder 410 can include both the node embeddings 420 and the graph embedding 422 derived from encoder 404, while also depends on the previously selected trailer from decoder 406 and selected tractor from decoder 408. Decoder 410 can determine an attention sublayer that communicates messages only to the context node, while the final probabilities are computed using a single-head attention mechanism.

In one embodiment, processor 102 can perform a masking scheme to prevent infeasible solutions to the ML problem 208. For example, the masking scheme can eliminate infeasible solutions that include trailers that are already located at their destinations, tractors with zero battery life, and nodes unreachable due to battery limits. Different masking schemes can be employed within decoders 406, 408 and 410 and can be adaptive according to the progress within a batch (e.g., multiple) of problem instance 402. By way of example, decoder 406 can employ a masking scheme to include trailers that are already located at their destinations, decoder 408 can employ a masking scheme to include tractors with zero battery life, and decoder 410 can employ a masking scheme to include nodes that may be unreachable due to battery limit. The masking scheme can ensure feasible and effective route planning by accounting for the tractor's position and battery capacity, along with the status of instance completion. In one embodiment, problem instance 402 can be considered as an incomplete instance if not all trailers have been delivered. Decoder 410 can apply the masking scheme in response to the problem instance 402 being incomplete. Nodes beyond the tractor's battery capacity are also masked, ensuring that only reachable destinations are considered. In one embodiment, problem instance 402 can be considered as a complete instance if all trailers have been delivered. In one embodiment, during training of ML model 110, the training can be performed on a batch of problem instances such that some problems can be completed earlier than others. Hence, in order to continue training, all nodes can be masked for the problem instances that are completed, except for the tractor's current location. Once all trailers have been delivered, the problem instance is deemed to be complete, nullifying the necessity for further tractor movement. Overall, there can be two masking schemes employed by decoder 410—a first one that takes place when the problem instance is not complete and nodes beyond the tractor's battery capacity are also masked, and a second one that, for a problem instance is completed (e.g., all trailers delivered), ensure that the rest of the problem instances in the batch will keep evolving and the cost function will not be recording wrong data.

In one embodiment, decoder 410 can generate a context embedding that includes the graph embedding, h^{N}, the current location of the tractor, denoted as h^{N}eₜ and h^{N}sₜ—if both the trailer and tractor reside on the same node, the destination node of the trailer is used, otherwise the trailer's current location is used. The graph embedding can be incorporated to capture the global view of the problem instance's graph structure, while the tractor's location and the trailer's location or destination depict the starting point and the intended target within the routing process. A horizontal concatenation operator denoted as [·,·,·] can be applied to yield the (3*dₕ)—dimensional vector Hₜ^{N}:

$${H}_{t}^{N} = [ {\overline{h}}^{N} , {h}^{N} {e}_{t} , {h}^{N} {s}_{t} ] \qquad ( 23 )$$

The vector Hₜ^{N} can be interpreted as the context embedding, which is the special context node at each decoding step t. This context embedding can be projected onto dₕ dimensions using linear propagation W^{Q}. Then, the projected vector Hₜ^{N} and the node embeddings 420 can be provided as inputs to a multi-head attention (MHA) layer, synthesizing a new context vector, Hₜ^{H+1}. Contrary to the self-attention used in encoder 404 that uses self-attention (e.g., key, value and query derive from the same data), decoder 410 uses cross-attention where the keys and values can be derived from the updated node embeddings hᵢ^{N} and the query can be derived from the context embedding.

As the locations of tractors and trailers, and the available chargers change with the decision making process 210, some information may not be integrated into the context node embedding as it is node-specific. Therefore, the updated node embeddings can be updated by including this information in the determination of keys and values within both the attention layer and the output layer of decoder 410W (e.g., probabilities), using the expression:

$${q}_{c} = {W}^{Q} {H}_{t}^{N} , {k}_{i} = {W}^{K} {h}_{i}^{N} + {W}_{d}^{K} {\hat{δ}}_{i}^{t} , {v}_{i} = {W}^{V} {h}_{i}^{N} + {W}_{d}^{V} {\hat{δ}}_{i}^{t} \qquad ( 24 )$$

where W_{d}^{K} and W_{d}^{V} are (dₖ×3) parameter matrices and \hat{δ}ᵢ^{t} is defined as the concatenation [acᵢ^{t}, aeᵢ^{t}, asᵢ^{t}]. The variable acᵢ^{t} denotes the charger availability at decoding step t, and the variables aeᵢ^{t} and asᵢ^{t} indicate the presence of electric tractors and semi-trailers at node i respectively. Summing the projections of both hᵢ and \hat{δ}ᵢ^{t} is equivalent to projecting the concatenation [hᵢ^{N}, \hat{δ}i, t] with a single ((dₕ+3)×dₖ)) matrix W. In one embodiment, similar attention mechanism can be implemented for other encoders, such as for re-determining the keys and values every time a state update occurs. A final decoder sub-layer with a single attention head in decoder 410 can generate the probability distribution Pₙ^{t} of the nodes. To generate the probability distribution Pₙ^{t}, the compatibility between the enhanced context u_{cj} and the updated node embeddings can be determined. Then, the determined compatibility can be clipped within a window [−C,C], where C is set to a predefined value (e.g., C=10) to control its entropy. Further, the masking scheme can be applied by decoder 410 and the probability vector can be determined using a softmax function. Each element of the probability vector represents the likelihood of selecting a node to be visited by the chosen tractor at step t. Similar to the other decoders, the nodes are selected by following either a greedy or sampling strategy.

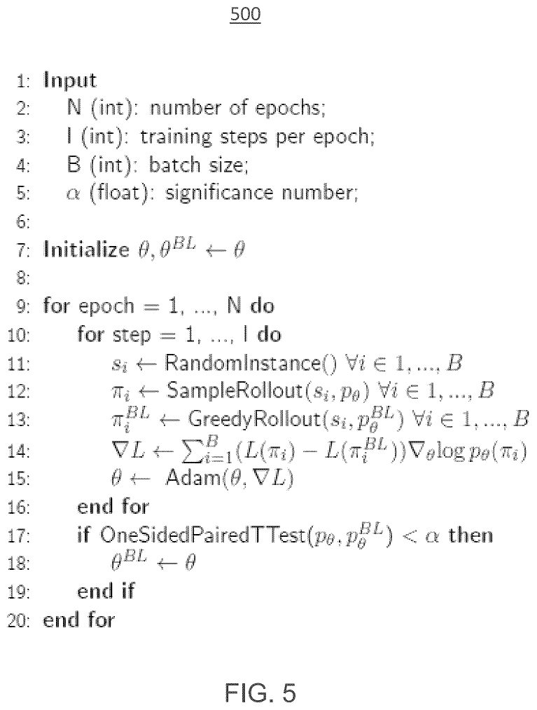

Processor 102 can perform reinforcement learning with rewards function to train ML model 110. The use of reinforcement learning can eliminate the need to wait for the ML model 110 to learn from optimal solutions (e.g., labeled data). The reward function can evaluate the quality of the solutions (e.g., sequences 214) generated in real-time, thereby enabling a more dynamic and iterative improvement of the solution process. In one embodiment, the ML model 110 can be trained using a policy gradient algorithm with greedy rollout baseline. An example of pseudocode for a set of instructions that can be stored in memory 104 and executed by processor 102 is shown in FIG. 5.

FIG. 5 is a diagram showing an example pseudocode of a set of instructions that can be executed to implement for decoupled electric vehicle routing in one embodiment. Descriptions of FIG. 5 can reference components shown in FIG. 1 to FIG. 4. Pseudocode for a set of instructions 500 is shown in FIG. 5. Instructions 500 can be executable code stored in memory 104 and can be executed by processor 102. Line 1 to line 5 can set the input parameters being received by processor 102 to execute instructions 500. At line 7, processor 102 can initialize parameters θ of a policy network p_{θ} and parameters θ^{BL} for a baseline network policy P_{θ}_{^{BL}}. The parameters θ and ABL can be trainable parameters of ML model 110. The baseline network policy P_{θ}_{^{BL}} and the policy network p_{θ} can be the architecture 400 shown in FIG. 4—where the baseline network policy is a greedy strategy and the policy network is a sampling strategy. By way of example, the policy network can generate probability vectors for the trailers, tractors and nodes at each decoding step from step 1 to step I (see line 10) in each epoch among epoch 1 to epoch N (see line 9), and picks an action with respect to these probabilities. The baseline network P_{θ}_{^{BL}} can determine rewards by being preset to pick trailers, tractors and nodes with maximum probability, thereby acting as a greedy roll-out baseline. At line 11, random problem instance (e.g., such as problem instance 402) can be generated. At line 12, the policy network p_{θ} can generate probability vectors for the trailers, tractors and nodes for the randomly generated problem instance. At line 13, the baseline network P_{θ}_{^{BL}} can pick trailers, tractors and nodes with maximum probability for the randomly generated problem instance.

A loss function, denoted as L(s)=E_{pθ}_{_{(π|θ)}} [L(π)] (see line 14 of instructions 500), serves as an expectation of the cost function (e.g., express (7)). Optimization of the loss function can be done via gradient descent, employing a gradient estimator with a baseline b(s) to reduce gradient variance and enhance the learning speed. This can be achieved by applying a Nesterov-accelerated Adaptive Moment Estimation (NAdam) optimizer to update the trainable parameters θ and θ^{BL} (see line 15). To maintain a robust baseline, the policy network p_{θ} and the baseline network p_{θ}_{^{BL}} can be compared at each epoch (see line 17 of instructions 500). If the latest policy network p_{θ} is significantly better than the baseline policy on a separate evaluation set (e.g., with 8000 instances) according to a one sided paired t-test (α=5%), the baseline network p_{θ}_{^{BL}} parameters θ^{BL} can be replaced with the parameters θ of the recently trained policy network. In case the baseline policy is updated, new evaluation instances are generated to prevent overfitting.

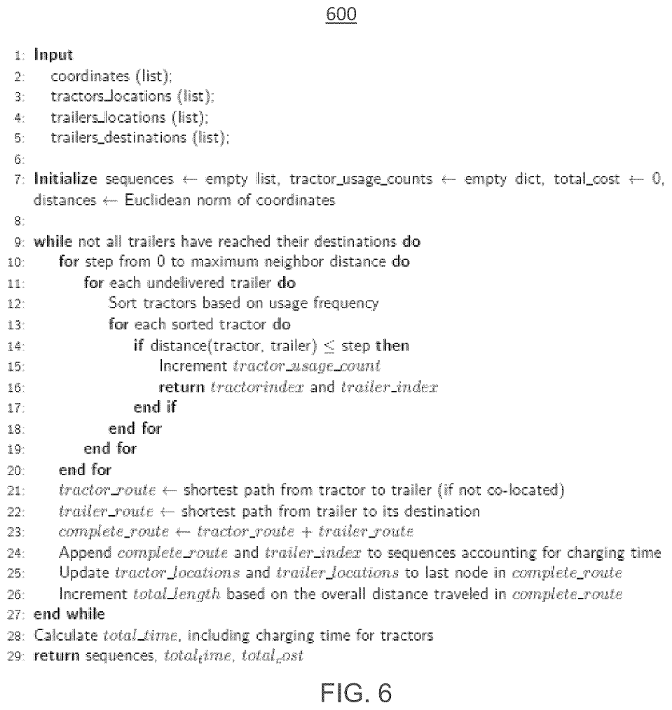

FIG. 6 is a diagram showing pseudocode of another set of instructions that can be executed to implement for decoupled electric vehicle routing in one embodiment. Description of FIG. 6 can reference components shown in FIG. 1 to FIG. 5. Pseudocode for a set of instructions 600 is shown in FIG. 6. Instructions 600 can be executable code stored in memory 104 and can be executed by processor 102. Line 1 to line 5 can set the input parameters being received by processor 102 to execute instructions 600. At line 7, processor 102 can initialize various parameters for execution of instructions 600. Instructions 600 can be executed by processor 102 to benchmark the routes being outputted by ML model 110 by using a deterministic and sequential approach.

Instructions 600 can select a trailer-tractor pair based on proximity, constructs the full path for the trailer's delivery, and then proceeds to the next trailer-tractor selection. At lines 10 to 11 of instruction 600, a trailer can be iteratively selected based on their closeness to available tractors, prioritizing trailers co-located with them. At line 12 of instruction 600, when multiple tractors are eligible, those less frequently utilized are selected. At lines 14 to 16 of instruction 600, once a trailer and a tractor (e.g., trailer-tractor pair) are determined, a complex graph network (e.g., NetworkX library), which may be stored in memory 104, can be used for finding the shortest route, first from the tractor to the trailer and subsequently to the trailer's destination. Following the route construction, both tractor and trailer states are updated at lines 21 to 23 of instructions 600. Instructions 600 can be executed iteratively until every trailer has been successfully delivered. In one embodiment, trailers can be indexed (e.g., based on their ID) and the indexing can impact the trailer selection thus impacting the route. Instructions 600 can provide determination of entire delivery routes of the trailers.

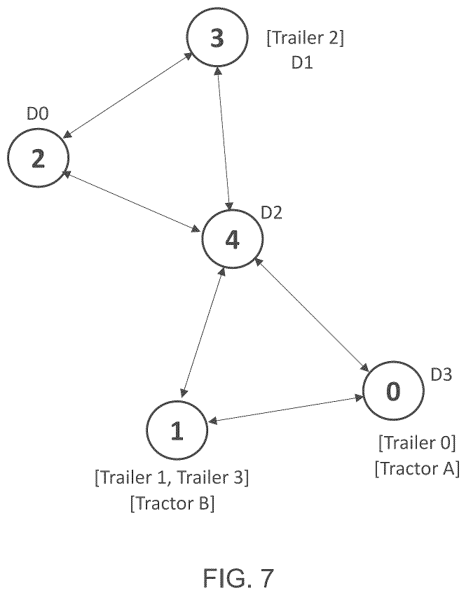

FIG. 7 is a diagram showing an example graph instance that can be used for training a machine learning model for decoupled electric vehicle routing in one embodiment. Description of FIG. 7 can reference components shown in FIG. 1 to FIG. 6. A graph instance 700 of graph G(V, E) is shown in FIG. 7. Graph instance 700 can be an example of problem instance 402. A graph instance of graph G(V, E) that models a network including n nodes, a fleet of m tractors, and k trailers that await delivery. In the example shown in FIG. 7, graph instance 700 can include 5 nodes with node ID from Node 0 to Node 4, 2 tractors with tractor ID TractorA and TractorB, and 4 trailers with trailer ID Trailer0 to Trailer3. The 4 trailers can be assigned to destinations D0 to D3. During simulation, the n nodes are sequentially placed within a unit square [0, 1]×[0, 1], following a uniform distribution. During operation in real time (e.g., when ML model 110 is deployed), the real physical locations of nodes, or charging stations 122, can be used. The node positioning is subject to a set of constraints, which are contingent on a determined distance threshold, set at 0.6. The set of constraints can include 1) maintain a distance between [threshold −0.1, threshold] from at least one other node, ensuring graph connectivity, 2) nodes are restricted to the [0, 1]×[0, 1] boundary, and 3) a minimum separation of threshold −0.1 from every other node is maintained to emulate the strategic placement in real-world electric vehicle routing networks, balancing accessibility with geographical coverage. Further, in simulation, each one of the n nodes is equipped with a random number of chargers, ranging from one to five, ensuring at least one charger per node. The k trailers are uniformly allocated to nodes. Each one of the k trailers is assigned a distinct destination node, different from its initial position. For example, in graph instance 700, Trailer1 is initially positioned at Node 1 and has a destination D1 at Node 3, and Trailer3 is also initially positioned at Node 1 but has a destination D3 at Node 0. The m tractors are uniformly distributed among nodes, starting with a battery level of 1, indicating that they are fully charged. The edges between nodes in graph instance 700 represent inter-node connectivity, and their weights correspond to the Euclidean distance between the connected nodes. Edges are established when the Euclidean distance between two nodes is below a predefined threshold (e.g., threshold=0.6), accounting for the battery limitations of electric tractors.

At each epoch, a new graph instance or a set of graph instance (e.g., problem instance 402) can be generated such that a diverse set of scenarios can be used for training ML model 110. Each epoch can include a plurality of graph instances to solve, such as 10,240 instances, and these graph instances can be processed in batches, such as a batch size of 1024, resulting in a total of 10 batches that can be processed in an epoch. At the end of each epoch, the policy network p_{θ} of the ML model 110 can be compared to the baseline network P_{θ}_{^{BL}} to assess its effectiveness. For an evaluation dataset of 8,000 random instances, new evaluation instances can be sampled whenever the baseline policy parameters θ^{BL} are updated to prevent overfitting. Additionally, a separate 8,000-instance validation dataset can be used to evaluate the generalizability of ML model 110. During training, ML model 110 can sample a trailer, tractor, and node based on the predicted probability distribution at each decoding step t, allowing a balance between exploration and exploitation. The evaluation and validation phases can adopt a greedy decoding strategy, in which the trailer, tractor, and node with the highest probability are chosen.

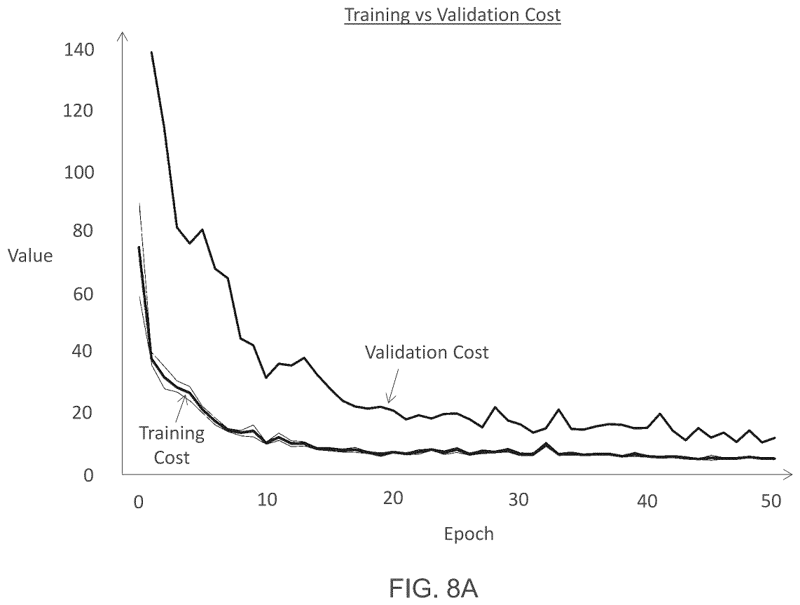

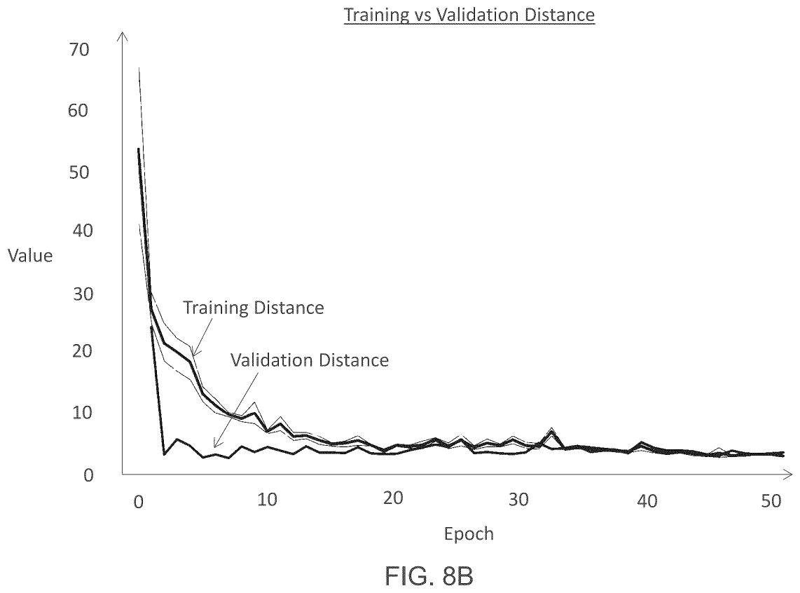

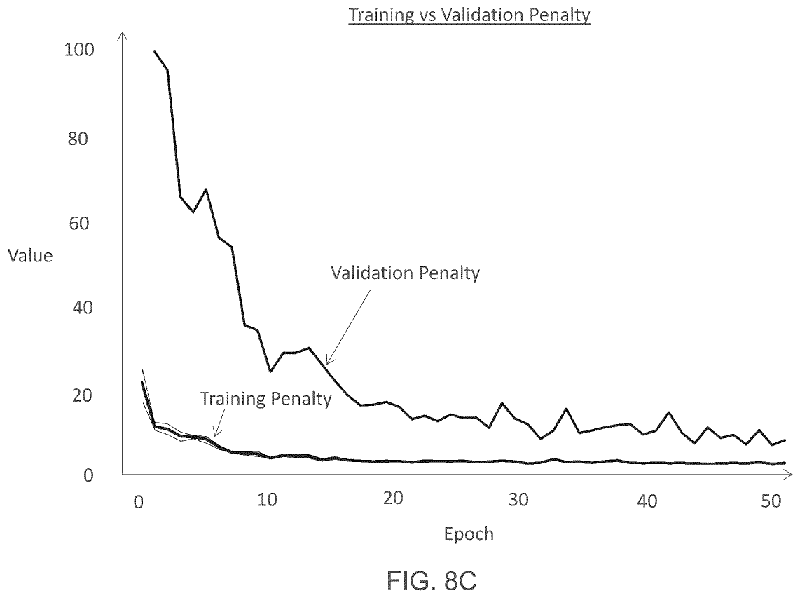

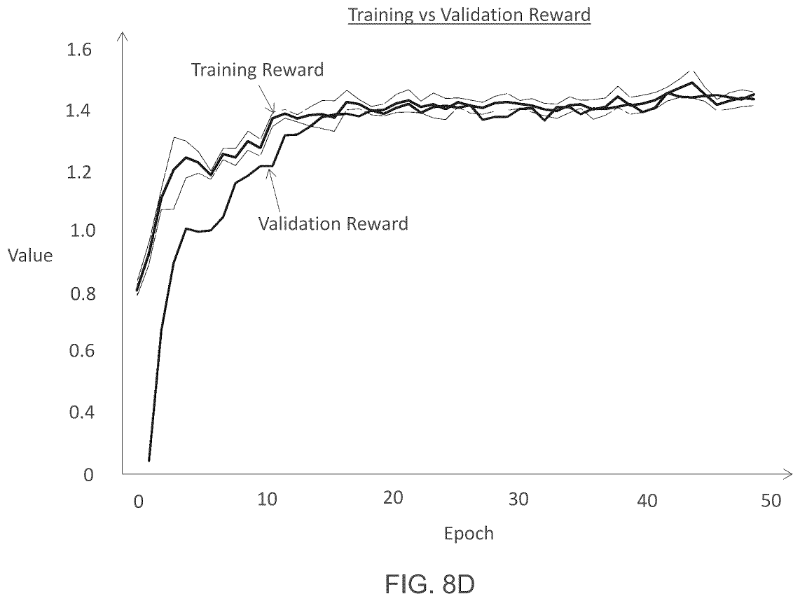

FIG. 8A to FIG. 8D are diagrams showing performance parameters from example implementations of a machine learning model for decoupled electric vehicle routing in one embodiment. Description of FIG. 8A to FIG. 8D can reference components shown in FIG. 1 to FIG. 7. Performance parameters of ML model 110 being applied on the graph instance 700 are shown FIG. 8A to FIG. 8D. For the performance parameters shown in FIG. 8A to FIG. 8D, encoder 404 of ML model 110 include three encoder layers with a learning rate of 10\hat{ }(−4) or 10⁻⁴. A batch size of 512 was used and the ML model was trained across 50 epochs. Additionally, trailer, tractor, and node features are embedded into a 128-dimensional space before being fed into the decoders 406, 408, 410, and the dimensionality of the hidden layers is set at 512. The parameters are initialized uniformly in range

$$[ \frac{- 1}{\sqrt{d}} , \frac{1}{\sqrt{d}} ]$$

with d the input dimension. The gradient vector norms are clipped within 1.0 to ensure model stability, and a value of the parameters α in line 5 of instruction 500 is set to 0.05.

To evaluate a learning efficacy and overall performance of the set of instructions 500 of ML model 110, processor 102 can run the ML model 110 on a set of instances, and compare its efficiency against a validation set of performance parameters. Over the course of the 50 epochs, the evolution of training and validation is monitored, providing a comprehensive insight into the learning curve of ML model 110. FIG. 8A shows the evolution of the cost function (expression (7)) of the training and the validation. FIG. 8B shows the evolution of the total distance (expression (8)) of the solutions (e.g., the routes) of the training and the validation. FIG. 8C shows the evolution of the penalty (expression (9)) of the training and the validation. FIG. 8D shows the evolution of the reward (expression (10)) of the training and the validation. As epochs progressed, the validation and training lines gradually converge, indicating performance improvement of the ML model 110 over time and that the ML model 110 learns to generalize to unseen data.

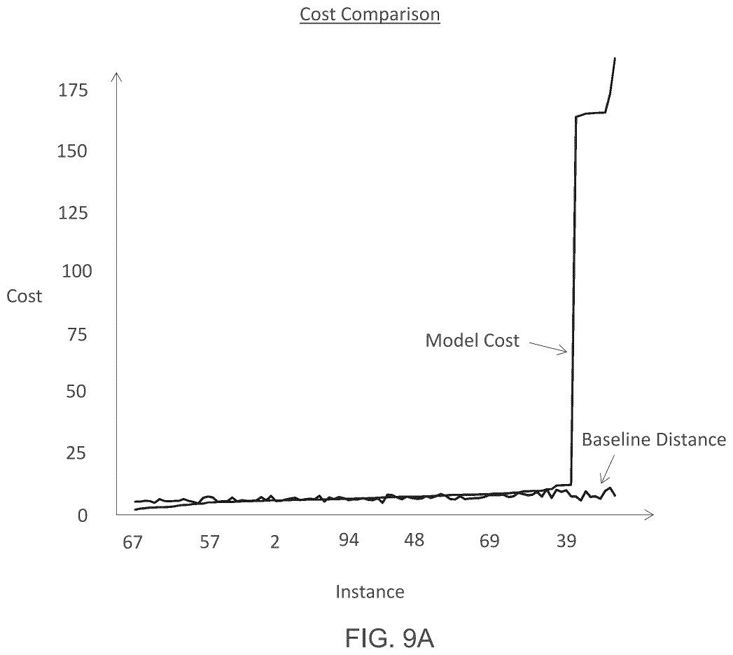

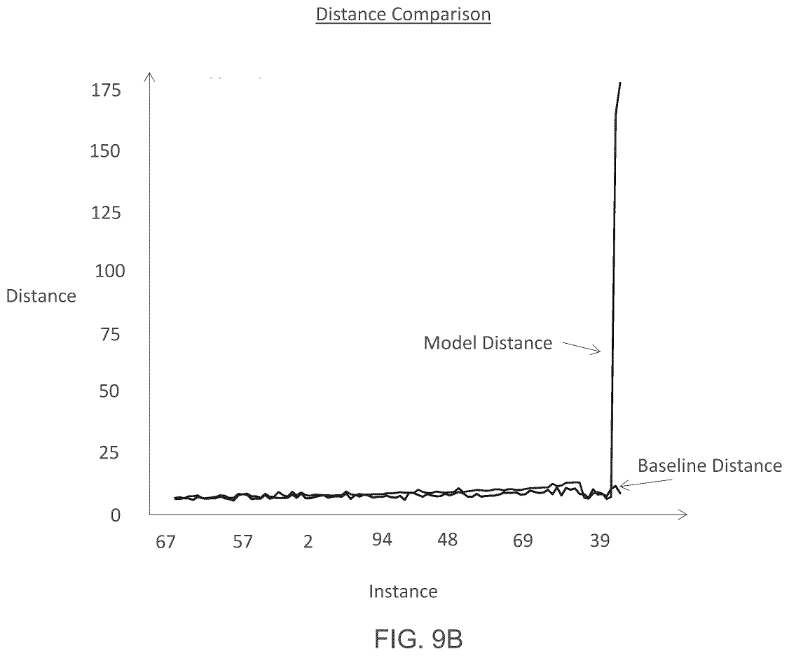

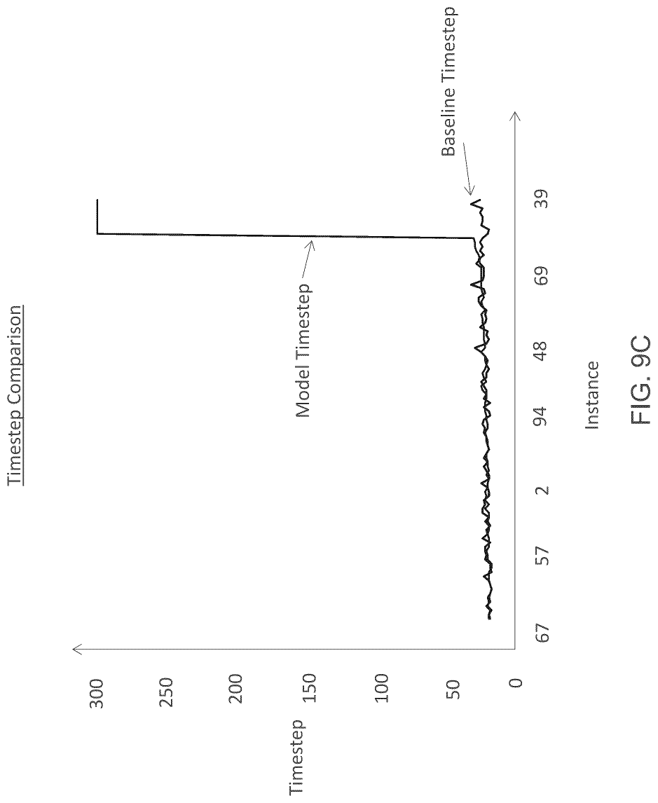

FIG. 9A to FIG. 9C are diagrams showing comparisons of the performance of a machine learning model trained using instructions 500 with instructions 600 for decoupled electric vehicle routing in one embodiment. Description of FIG. 9A to FIG. 9C can reference components shown in FIG. 1 to FIG. 8D. The performance and efficiency of ML model 110 can be benchmarked against the baseline as shown by instructions 600. In the comparisons shown in FIG. 9A to FIG. 9C, comparisons are made for one-hundred random problem instances, such a problem instance 402. In FIG. 9A, the baseline's solution total distance is compared against the cost function of the ML model 110. In FIG. 9B, the baseline's solution total distance is compared against the solution total distance of the ML model 110. In FIG. 9C, the required time steps to solve the problems for both the baseline and the model are compared. The one-hundred instances are ordered based on the cost function of the ML model 110. While there were sporadic instances where the model required excessive time or did not converge to an optimal solution, there are also scenarios in which the model demonstrated superior performance when compared to the baseline.

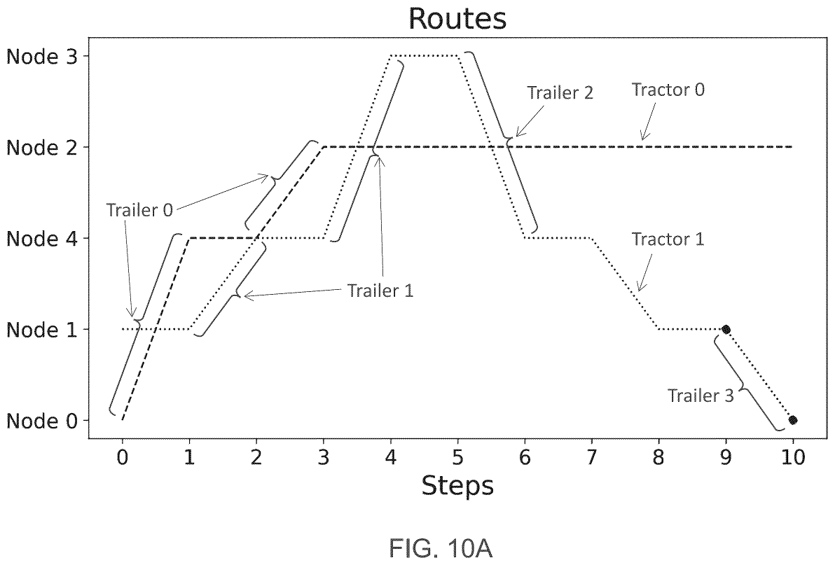

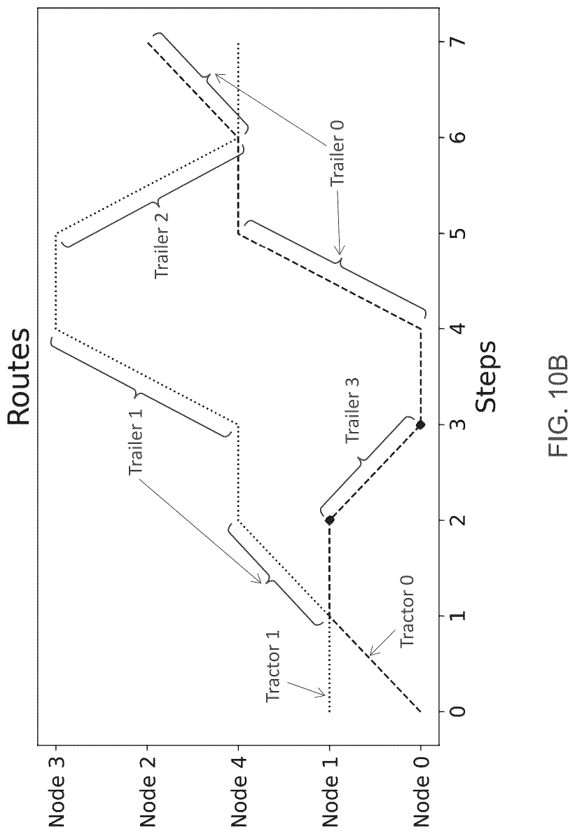

FIG. 10A is a diagram showing a set of solutions resulted from a baseline network for decoupled electric vehicle routing in one embodiment. FIG. 10B is a diagram showing a set of solutions resulted from a policy network for decoupled electric vehicle routing in one embodiment. Descriptions of FIG. 10A and FIG. 10B can reference components shown in FIG. 1 to FIG. 9C. Baseline solutions derived from instructions 600 are shown in FIG. 10A. Solutions, such as routes of the trailers determined by the trained ML model 110, for the graph instance 700 in FIG. 7 are shown in FIG. 10B. The solutions in FIG. 10A and FIG. 10B reflect how the trailers in graph instance 700 travel from their initial positions to their destinations, and the decoding steps where the travel occurred.

Comparing FIG. 10A with FIG. 10B, the baseline solution can determine the path for the trailers but does not maximize fleet utilization. For example, as shown in FIG. 10A, Tractor 0 only delivers Trailer 0, while Tractor 1 handles all remaining trailers. The distribution in FIG. 10A results in an extended operational span of 9 timesteps, leading to a solution total distance of 3.69. However, in FIG. 10B, the ML model 110 adopts a dynamic approach that leads to more efficient fleet utilization when compared to the baseline network. As shown in FIG. 10B, the ML model 110 follows the shortest paths for tractor movement across the nodes, and achieves optimal fleet use. For example, in FIG. 10B, Tractor 0 delivered Trailer 3 and Trailer 0 to their destinations while Tractor 1 delivered Trailer 1 and Trailer 2 to their destinations. The distribution in FIG. 10B results in a cost function of 2.89, with a cumulative distance traveled of 3.73, a reward of 0.85, no penalties, and a total of 6-time steps. The ML model 110 can operate by taking sequential actions and adapting its strategy in response to state changes, in contrast to the baseline approach that determines a complete delivery route in one go. This iterative methodology can enhance flexibility of ML model 110, which may enable it to identify the most suitable pairing of tractor, trailer, and node at each step. As a result, the ML model 110 can continually refine its decisions based on evolving routing conditions and, if necessary, implement trailer-swapping strategies.

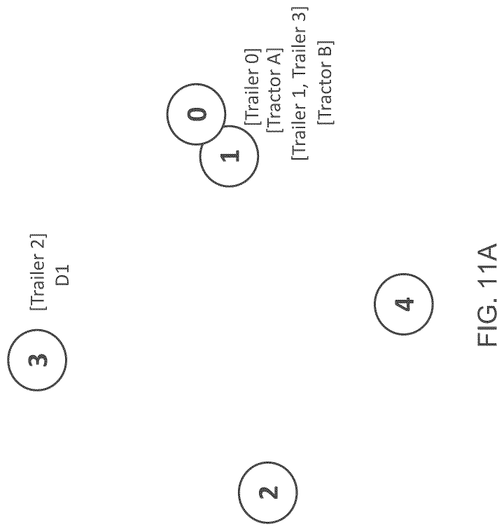

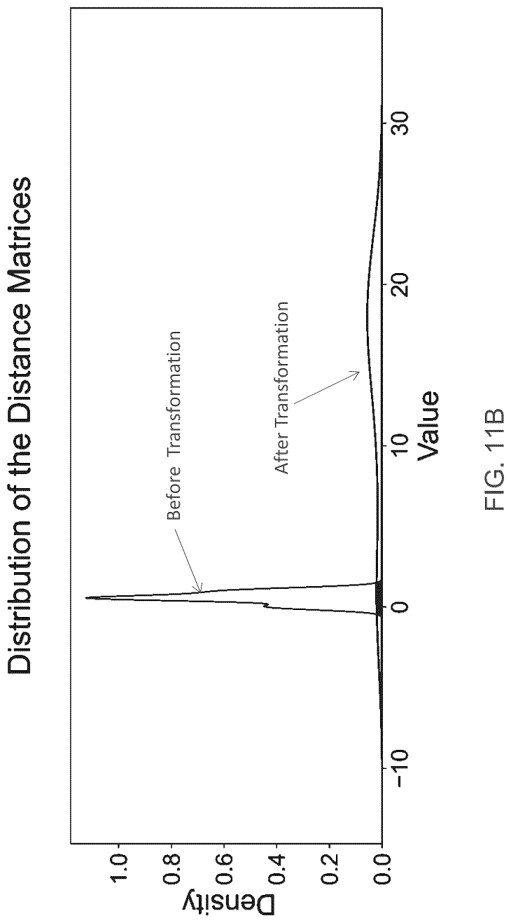

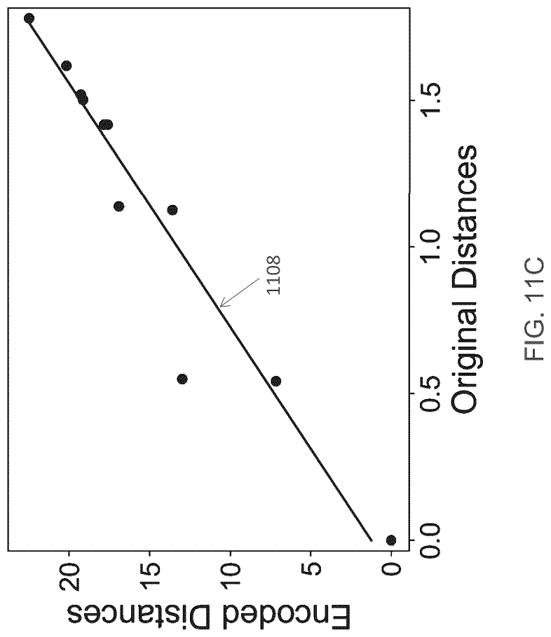

FIG. 11A is a diagram showing embeddings of a graph instance 700 for decoupled electric vehicle routing in one embodiment. Description of FIG. 11A can reference components shown in FIG. 1 to FIG. 10B. In one embodiment, processor 102 or encoder 404 can generate 2D embedded data of a graph instance, as shown in FIG. 11A, by deriving and projecting node embeddings 420 from the dₕdimensions to a 2D plane using principle component analysis (PCA) techniques. Processor 102 or encoder 404 can also perform K-means clustering on the 2D embedded data to produce clusters that align with the sequence of nodes in the solution route. As a result of the K-means clustering, nodes having both tractors and trailers, such as Node 0 and Node 1, cluster together. Nodes having trailers but not tractors, such as Node 3, can form distinct clusters. Nodes not containing any of the two, such as Node 2 and Node 4, form another.

The 2D embeddings, such as the ones shown in FIG. 11A, can define a learning capability of encoder 404 (e.g., whether encoder 404 learned any new information). Referring to FIG. 11B, before a transformation from the dₕdimensions to the 2D embeddings, a 5-dimensional (5D) input, such as raw data in problem instance 402, that can include node coordinates, availability of chargers, availability of tractors, and availability trailers (or availability trailers per node) can be provided to encoder 404. Encoder 404 can encode the 5D input into node embeddings having dₕdimensions, such as 128-dimensions. Then, the encoded data having the dₕ dimensions can be transformed to the 2D embeddings. As shown in FIG. 11B, before the transformation, the distribution of distances between nodes in the 5D input is narrower than the encoded data having dₕ dimensions. Referring to FIG. 11C, processor 102 can generate a two-sampled QQ plot 1106 of the distance distribution after the transformation. Processor 102 can determine the divergence between the actual QQ-plot and its linear prediction 1108 by determining the Euclidean distances between the respective points of the QQ-plot and its linear prediction 1108. Metrics of the Euclidean distances, such as mean, median, and standard deviation, can be used by the processor 102 to determine the learning capability of encoder 404.

The state changes performed by the decision making process 210 according to the actions can generate sequences of states, and the sequences can be routes to deliver trailers to their destinations. The sequences can reflect different decision making under different states of G(V, E). ML model 110 can then be trained under reinforcement learning by learning which decision to make under different circumstances. By way of example, ML model 110 can learn to select a different tractor to deliver a trailer if an initial tractor does not have sufficient battery to deliver the trailer. Further, the reinforcement learning can be performed in real-time, such as after deployment of the ML model 110. Thus, ML model 110 can be trained as a reinforcement learning agent that can learn and adapt to generalize various decisions without a need to compare large number of solutions (e.g., routes) for selecting an optimal solution. The environment for the reinforcement learning can be set by the graph G(V, E) and the interaction between the ML model and the environment can be modeled by decision making process 210.

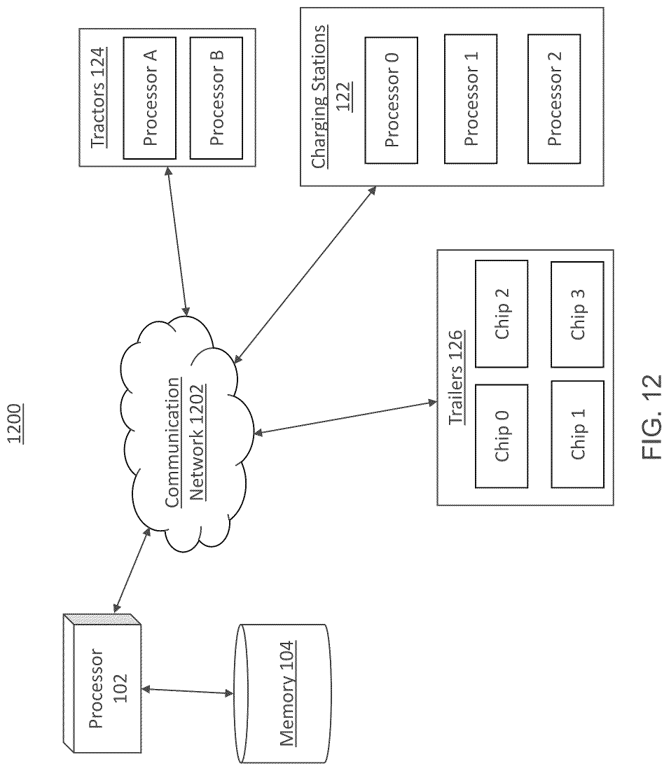

FIG. 12 is a diagram showing an example system that can utilize a machine learning model trained for decoupled electric vehicle routing in one embodiment. In an example system 1200 shown in FIG. 12, processor 102 can run ML model 110 to determine optimal routes for delivering trailers 126 to their assigned destinations. Processor 102 can communicate with processors in tractors 124 (e.g., processor A and processor B for tractors A and B) and/or charging stations 122 (e.g., processor 0, processor 1 and processor 2 for nodes 0, 1, 2) via a communication network 1202, such as the Internet, a cellular network, or other types of communication network. By way of example, processors in tractors 124 can communicate information such as battery level of tractors 124, locations of tractors 124, whether trailers are coupled or decoupled from tractors 124, and other information of the states of tractors 124. By way of example, processors in charging stations 122 can communicate information such as number of available chargers, number of tractors being charged at the charging stations 122, and other information of the states of charging stations 122. In one embodiment, each one of trailers 126 can be coupled to a device that can communicate locations of the trailers 126 to processor 102 via communication network 1202. In one embodiment, the devices coupled to trailers 126 can be active or passive devices such as radio frequency identity (RFID) chips that can communicate with processor 102 to provide information, such as locations of trailers 126, to processor 102. In one embodiment, processor 102 can periodically pull location data from the chips coupled to trailers 126 to determine locations of trailers 126. In one embodiment, the chips coupled to trailers 126 can provide location information to processors of tractors 124 and/or charging stations 122 and the processors can forward the location information to processor 102. In one embodiment, the devices coupled to trailers 126 can also be programmed with destinations of trailers 126 and processor 102 can pull (e.g., autonomous retrieval of data without user input and/or request) the destination information from the devices via communication network 1202.

When ML model 110 is being run by processor 102 in real-time, processor 102 can use the information received via communication network 1202 to run ML model 110 as described herein. For example, based on the information received via communication network 1202, processor 102 can generate a problem instance (e.g., problem instance 402) to define a current state of the charging network 120 in the form of a state of graph G(V, E). The generated problem instance can indicate locations of trailers, which trailers are coupled to which tractors, which trailers are decoupled from tractors, which tractors are not carrying trailers, battery status of tractors, availability of charging stations, and other information. Once the problem instance is generated, processor 102 can execute decision making process 210 to model decision making by ML model 110 to make selections (e.g., decoder selections in architecture 400) to generate a sequence of states of G(V, E). The sequence of states can represent transitions of trailers and tractors in the charging network 120, such as movement of tractors, coupling and decoupling of trailers to and from tractors, and movement of trailers to their assigned destinations. The process from the generation of the problem instance to the generation of the sequence of states can be performed by processor 102 under either the offline mode or the online mode (see FIG. 1).

In one embodiment, processor 102 can run the ML model 110 to determine an optimal sequence of states of each tractor and/or trailer in charging network 120. Referring to FIG. 3A, if input data being provided to processor 102 indicates a current state of charging network 120 being the state shown in FIG. 3A, processor 102 can determine routing data indicating optimal trailer-tractor pair (e.g., coupling) and routes for delivering the trailers to their destinations. Processor 102 can generate the routing data that represent the determined optimal trailer-tractor pair and routes, and broadcast the routing data to the processors of the tractors 124. In one embodiment, if tractors 124 are autonomous vehicles, the tractors 124 can autonomously travel to charging stations 122 if charging is needed and/or travel to a location of a trailer to be coupled with the tractor according to the routing data. Chips coupled to trailers 126 can also receive the routing data such that tractors approaching the trailers can initiate verification processes to ensure that the correct trailer is being coupled to the correct tractor according to the routing data. In one embodiment, in offline mode, processor 102 can distribute the generated routing data to processors of the tractors over a network, such as the Internet, in order for the processors of the tractors to control the tractors to navigate according to the routing data. In one embodiment, in online mode, processor 102 can continuously update the routing data and each time the routing data is updated, distribute the updated routing data to processors of the tractors over a network, such as the Internet, in order for the processors of the tractors to update controls of the tractors to navigate according to the updated routing data.

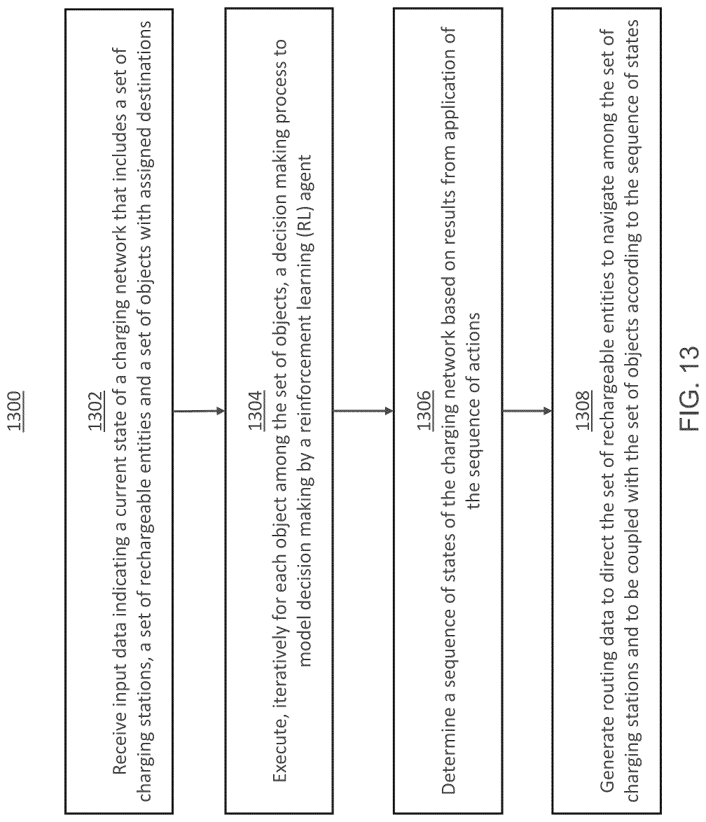

FIG. 13 illustrates a flow diagram of a process to implement decoupled electric vehicle routing in one embodiment. The process 1300 shown in FIG. 13 can include one or more operations, actions, or functions as illustrated by one or more of blocks 1302, 1304, 1306 and/or 1308. Although illustrated as discrete blocks, various blocks can be divided into additional blocks, combined into fewer blocks, eliminated, performed in different order, or performed in parallel, depending on the desired implementation.

Process 1300 can be performed by a processor, such as processor 102 described in the present disclosure. In one embodiment, the operations illustrated by blocks in FIG. 13 can be digitally encoded as individual blocks of program code. The blocks of program code can be executed by the processor to perform the operations illustrated by blocks in FIG. 13. Process 1300 can begin at block 1302. At block 1302, the processor can receive input data indicating a current state of a charging network that includes a set of charging stations, a set of rechargeable entities and a set of objects with assigned destinations. In one embodiment, the set of rechargeable entities can include at least one of a non-autonomous electric tractor and an autonomous electric tractor.

In one embodiment, the processor can encode the current state of the charging network to generate a set of node embeddings that are vector representations of the set of charging stations in the charging network. The processor can further execute, iteratively for each object among the set of objects, the decision making process by decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network. The specific action can be formed based on the specific object, the specific rechargeable entity and the specific charging station.

Process 1300 can proceed from block 1302 to block 1304. At block 1304, the processor can execute, iteratively for each object among the set of objects, a decision making process to model decision making by a reinforcement learning (RL) agent. The decision making can include application of a sequence of actions on the charging network, and an application of each action among the sequence of actions changes a state of the charging network. In one embodiment, the RL agent can be an attention based deep neural network. In one embodiment, each action among the sequence of actions can be a 5-tuples representing a starting charging station, an ending charging station, a specific rechargeable entity, a specific object, and a decoding step of the iterative execution of the decision making process.

Process 1300 can proceed from block 1304 to block 1306. At block 1306, the processor can determine a sequence of states of the charging network based on results from application of the sequence of actions. The sequence of states can represent transitions of the set of rechargeable entities and the set of objects to complete delivery of the set of objects to the assigned destinations.

Process 1300 can proceed from block 1306 to block 1308. At block 1308, the processor can generate routing data to direct the set of rechargeable entities to navigate among the set of charging stations and to be coupled with the set of objects according to the sequence of states. In one embodiment, the processor can further distribute the routing data to a plurality of processors of the set of rechargeable entities.

In one embodiment, the processor can determine a cost associated with the sequence of actions, wherein the cost is based on a distance traveled by the set of rechargeable entities under the sequence of states, a penalty that represents stagnation of the set of rechargeable entities, and a reward that encourages selection of less-utilized rechargeable entities and minimize time for delivery of the set of objects. The processor can further train the RL agent using the determined cost.

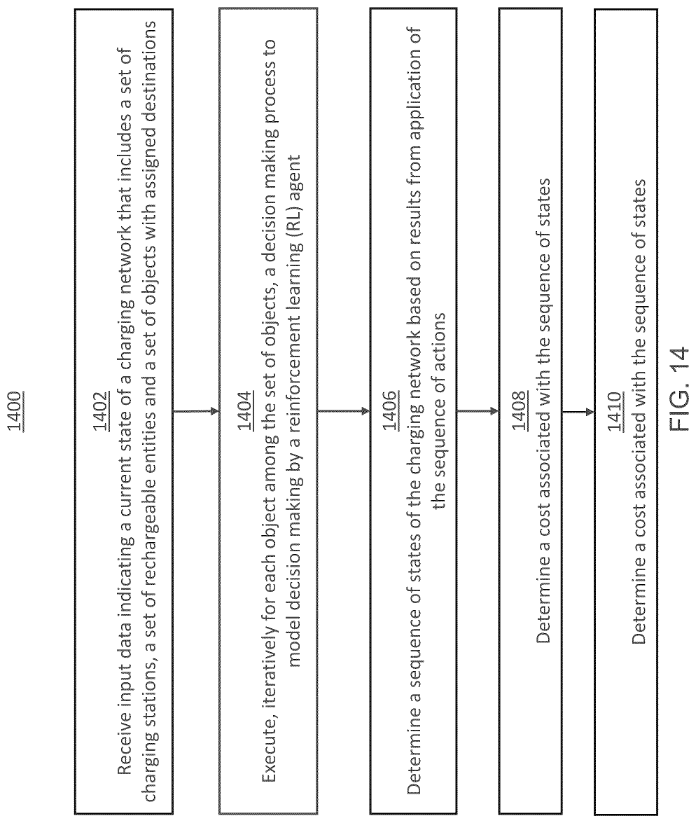

FIG. 14 illustrates a flow diagram of another process to implement decoupled electric vehicle routing in one embodiment. The process 1400 shown in FIG. 14 can include one or more operations, actions, or functions as illustrated by one or more of blocks 1402, 1404, 1406, 1408 and/or 1410. Although illustrated as discrete blocks, various blocks can be divided into additional blocks, combined into fewer blocks, eliminated, performed in different order, or performed in parallel, depending on the desired implementation.

Process 1400 can be performed by a processor, such as processor 102 described in the present disclosure. In one embodiment, the operations illustrated by blocks in FIG. 14 can be digitally encoded as individual blocks of program code. The blocks of program code can be executed by the processor to perform the operations illustrated by blocks in FIG. 14. Process 1400 can begin at block 1402. At block 1402, the processor can receive input data indicating a current state of a charging network that includes a set of charging stations, a set of rechargeable entities and a set of objects with assigned destinations. In one embodiment, the set of rechargeable entities can include at least one of a non-autonomous electric tractor and an autonomous electric tractor.

In one embodiment, the processor can encode the current state of the charging network to generate a set of node embeddings that are vector representations of the set of charging stations in the charging network. The processor can further execute, iteratively for each object among the set of objects, the decision making process by decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network. The specific action can be formed based on the specific object, the specific rechargeable entity and the specific charging station.

Process 1400 can proceed from block 1402 to block 1404. At block 1404, the processor can execute, iteratively for each object among the set of objects, a decision making process to model decision making by a reinforcement learning (RL) agent. The decision making can include application of a sequence of actions on the charging network, and an application of each action among the sequence of actions changes a state of the charging network. In one embodiment, the RL agent can be an attention based deep neural network. In one embodiment, each action among the sequence of actions can be a 5-tuples representing a starting charging station, an ending charging station, a specific rechargeable entity, a specific object, and a decoding step of the iterative execution of the decision making process.

Process 1400 can proceed from block 1404 to block 1406. At block 1406, the processor can determine a sequence of states of the charging network based on results from application of the sequence of actions. The sequence of states can represent transitions of the set of rechargeable entities and the set of objects to complete delivery of the set of objects to the assigned destinations. Process 1400 can proceed from block 1406 to block 1408. At block 1408, the processor can determine a cost associated with the sequence of states. The cost can be based on at least one or more of a distance traveled by the set of rechargeable entities under the sequence of states, a penalty that represents stagnation of the set of rechargeable entities, and a reward that encourages selection of less-utilized rechargeable entities and minimize time for delivery of the set of objects. Process 1400 can proceed from block 1408 to block 1410. At block 1410, the processor can train the RL agent using the determined cost.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

The following numbered examples are embodiments.

1. A computer-implemented method of receiving input data indicating a current state of a charging network that includes a set of charging stations, a set of rechargeable entities and a set of objects with assigned destinations, executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network, determining a sequence of states of the charging network based on results from application of the sequence of actions, wherein the sequence of states represent transitions of the set of rechargeable entities and the set of objects to complete delivery of the set of objects to the assigned destinations, and generating routing data to direct the set of rechargeable entities to navigate among the set of charging stations and to be coupled with the set of objects according to the sequence of states.

2. The computer-implemented method of Example 1, wherein, the set of rechargeable entities include at least one of a non-autonomous electric tractor and an autonomous electric tractor and the set of objects include semi-trailers.

3. The computer-implemented method of any one of Examples 1 to 2, further comprising distributing the routing data to a plurality of processors of the set of rechargeable entities.

4. The computer-implemented method of any one of Examples 1 to 3, wherein the RL agent is an attention based deep neural network.

5. The computer-implemented method of any one of Examiners 1 to 4, further comprising, encoding the current state of the charging network to generate a set of node embeddings that are vector representations of the set of charging stations in the charging network, wherein executing, iteratively for each object among the set of objects, the decision making process comprises decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network, wherein the specific action is formed based on the specific object, the specific rechargeable entity and the specific charging station.

6. The computer-implemented method of any one of Examples 1 to 5, wherein each action among the sequence of actions is a 5-tuples representing a starting charging station, an ending charging station, a specific rechargeable entity, a specific object, and a decoding step of the iterative execution of the decision making process.

7. The computer-implemented method of any one of Examples 1 to 6, further comprising determining a cost associated with the sequence of actions, wherein the cost is based on a distance traveled by the set of rechargeable entities under the sequence of states, a penalty that represents stagnation of the set of rechargeable entities, and a reward that encourages selection of less-utilized rechargeable entities and minimize time for delivery of the set of objects, and the computer-implemented method further comprising training the RL agent using the determined cost.

8. A system comprising a memory configured to store parameters representing a reinforcement learning (RL) agent, a processor configured to receive input data indicating a current state of a charging network that includes a set of charging stations, a set of rechargeable entities and a set of objects with assigned destinations, execute, iteratively for each object among the set of objects, a decision making process to model decision making by the RL agent, wherein the decision making process includes application of a sequence of actions on the charging network, and an application of each action among the sequence of actions changes a state of the charging network, determine a sequence of states of the charging network based on results from application of the sequence of actions, wherein the sequence of states represent transitions of the set of rechargeable entities and the set of objects to complete delivery of the set of objects to the assigned destinations, generate routing data to direct the set of rechargeable entities to navigate among the set of charging stations and to be coupled with the set of objects according to the sequence of states.

9. The system of Example 8, wherein the set of rechargeable entities are electric tractors and the set of objects are semi-trailers.

10. The system of any one of Examples 8 to 9, wherein the set of rechargeable entities are autonomous electric tractors and the set of objects are semi-trailers.

11. The system of any one of Examples 8 to 10, wherein the RL agent is an attention based deep neural network.

12. The system of any one of Examples 8 to 11, wherein the processor is configured to encode the current state of the charging network to generate a set of node embeddings that are vector representations of the set of charging stations in the charging network, wherein iterative execution of the decision making process for each object among the set of objects comprises decode a selection of a specific object using the set of node embeddings, decode a selection of a specific rechargeable entity for the specific object based on the set of node embeddings and states of the set of rechargeable entities, decode a selection of a specific charging station to be visited by the specific rechargeable entity based on states of the set of rechargeable entities and states of the set of objects, and apply a specific action that updates the state of the charging network, wherein the specific action is formed based on the specific object, the specific rechargeable entity and the specific charging station.

13. The system of any one of Examples 8 to 12, wherein each action among the sequence of actions is a 5-tuples representing a starting charging station, an ending charging station, a specific rechargeable entity, a specific object, and a decoding step of the iterative execution of the decision making process.

14. The system of any one of Examples 8 to 13, wherein the processor is configured to determine a cost associated with the sequence of actions, wherein the cost is based on a distance traveled by the set of rechargeable entities under the sequence of states, a penalty that represents stagnation of the set of rechargeable entities and a reward that encourages selection of less-utilized rechargeable entities and minimize time for delivery of the set of objects, and the processor is further configured to train the RL agent using the determined cost.

15. A computer-implemented method comprising receiving input data indicating a current state of a charging network that includes a set of charging stations, a set of rechargeable entities and a set of objects with assigned destinations, executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network, determining a sequence of states of the charging network based on results from application of the sequence of actions, wherein the sequence of states represent transitions of the set of rechargeable entities and the set of objects to complete delivery of the set of objects to the assigned destinations, determining a cost associated with the sequence of states, wherein the cost is based on at least one or more of a distance traveled by the set of rechargeable entities under the sequence of states, a penalty that represents stagnation of the set of rechargeable entities and a reward that encourages selection of less-utilized rechargeable entities and minimize time for delivery of the set of objects. The computer-implemented method further comprising training the RL agent using the determined cost.

16. The computer-implemented method of Example 15, wherein the set of rechargeable entities are electric tractors and the set of objects are semi-trailers.

17. The computer-implemented method of any one of Example 15 to 16, wherein the set of rechargeable entities are autonomous electric tractors the set of objects are semi-trailers.

18. The computer-implemented method of any one of Examples 15 to 17, wherein the RL agent is an attention based deep neural network.

19. The computer-implemented method of any one of Examples 15 to 18, further comprising encoding the current state of the charging network to generate a set of node embeddings that are vector representations of the set of charging stations in the charging network, wherein executing, iteratively for each object among the set of objects, the decision making process comprises decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network, wherein the specific action is formed based on the specific object, the specific rechargeable entity and the specific charging station.

20. The computer-implemented method of any one of Examples 15 to 19, wherein the sequence of actions is a 5-tuples representing a starting charging station, an ending charging station, a specific rechargeable entity, a specific object, and a decoding step of the iterative execution of the decision making process.

21. A computer program product comprising a non-transitory computer readable storage medium having program instructions embodied therewith, the program instructions readable by a processor to cause the processor to perform the operations of receiving input data indicating a current state of a charging network that includes a set of charging stations, a set of rechargeable entities and a set of objects with assigned destinations, executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network, determining a sequence of states of the charging network based on results from application of the sequence of actions, wherein the sequence of states represent transitions of the set of rechargeable entities and the set of objects to complete delivery of the set of objects to the assigned destinations, and generating routing data to direct the set of rechargeable entities to navigate among the set of charging stations and to be coupled with the set of objects according to the sequence of states.

22. The computer program product of Example 21, wherein, the set of rechargeable entities include at least one of a non-autonomous electric tractor and an autonomous electric tractor and the set of objects include semi-trailers.

23. The computer program product of any one of Examples 21 to 22, wherein the program instructions are readable by the processor to cause the processor to perform the operations of distributing the routing data to a plurality of processors of the set of rechargeable entities.

24. The computer program product of any one of Examples 21 to 23, wherein the RL agent is an attention based deep neural network.

25. The computer program product of any one of Examples 21 to 24, wherein the program instructions are readable by the processor to cause the processor to perform the operations of encoding the current state of the charging network to generate a set of node embeddings that are vector representations of the set of charging stations in the charging network, wherein executing, iteratively for each object among the set of objects, the decision making process comprises decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network, wherein the specific action is formed based on the specific object, the specific rechargeable entity and the specific charging station.

26. The computer program product of any one of Examples 21 to 25, wherein each action among the sequence of actions is a 5-tuples representing a starting charging station, an ending charging station, a specific rechargeable entity, a specific object, and a decoding step of the iterative execution of the decision making process.

27. The computer program product of any one of Examples 21 to 22, wherein the program instructions are readable by the processor to cause the processor to perform the operations of determining a cost associated with the sequence of actions, wherein the cost is based on a distance traveled by the set of rechargeable entities under the sequence of states, a penalty that represents stagnation of the set of rechargeable entities, and a reward that encourages selection of less-utilized rechargeable entities and minimize time for delivery of the set of objects, and the computer-implemented method further comprising training the RL agent using the determined cost.

28. A system comprising a memory configured to store parameters representing a reinforcement learning (RL) agent, a processor configured to receive input data indicating a current state of a charging network that includes a set of charging stations, a set of rechargeable entities and a set of objects with assigned destinations, execute, iteratively for each object among the set of objects, a decision making process to model decision making by a reinforcement learning (RL) agent, wherein the decision making includes application of a sequence of actions on the charging network, and an application of each action among the sequence of actions changes a state of the charging network, determine a sequence of states of the charging network based on results from application of the sequence of actions, wherein the sequence of states represent transitions of the set of rechargeable entities and the set of objects to complete delivery of the set of objects to the assigned destinations, determine a cost associated with the sequence of states, wherein the cost is based on at least one or more of a distance traveled by the set of rechargeable entities under the sequence of states, a penalty that represents stagnation of the set of rechargeable entities and a reward that encourages selection of less-utilized rechargeable entities and minimize time for delivery of the set of objects. The processor is further configured to train the RL agent using the determined cost.

29. The system of Example 28, wherein the set of rechargeable entities are electric tractors and the set of objects are semi-trailers.

30. The system of any one of Examples 28 to 29, wherein the set of rechargeable entities are autonomous electric tractors and the set of objects are semi-trailers.

31. The system of any one of Examples 28 to 30, wherein the RL agent is an attention based deep neural network.

32. The system of any one of Examples 28 to 31, wherein the processor is configured to encode the current state of the charging network to generate a set of node embeddings that are vector representations of the set of charging stations in the charging network, wherein iterative execution of the decision making process for each object among the set of objects comprises decode a selection of a specific object using the set of node embeddings, decode a selection of a specific rechargeable entity for the specific object based on the set of node embeddings and states of the set of rechargeable entities, decode a selection of a specific charging station to be visited by the specific rechargeable entity based on states of the set of rechargeable entities and states of the set of objects, and apply a specific action that updates the state of the charging network, wherein the specific action is formed based on the specific object, the specific rechargeable entity and the specific charging station.

33. The system of any one of Examples 28 to 32, wherein each action among the sequence of actions is a 5-tuples representing a starting charging station, an ending charging station, a specific rechargeable entity, a specific object, and a decoding step of the iterative execution of the decision making process.

34. The system of any one of Examples 8 to 13, wherein the processor is configured to determine a cost associated with the sequence of actions, wherein the cost is based on a distance traveled by the set of rechargeable entities under the sequence of states, a penalty that represents stagnation of the set of rechargeable entities and a reward that encourages selection of less-utilized rechargeable entities and minimize time for delivery of the set of objects, and the processor is further configured to train the RL agent using the determined cost.

35. A computer program product comprising a non-transitory computer readable storage medium having program instructions embodied therewith, the program instructions readable by a processor to cause the processor to perform the operations of receiving input data indicating a current state of a charging network that includes a set of charging stations, a set of rechargeable entities and a set of objects with assigned destinations, executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network, determining a sequence of states of the charging network based on results from application of the sequence of actions, wherein the sequence of states represent transitions of the set of rechargeable entities and the set of objects to complete delivery of the set of objects to the assigned destinations, determining a cost associated with the sequence of states, wherein the cost is based on at least one or more of a distance traveled by the set of rechargeable entities under the sequence of states, a penalty that represents stagnation of the set of rechargeable entities and a reward that encourages selection of less-utilized rechargeable entities and minimize time for delivery of the set of objects. The computer-implemented method further comprising training the RL agent using the determined cost.

36. The computer program product of Example 35, wherein the set of rechargeable entities are electric tractors and the set of objects are semi-trailers.

37. The computer program product of any one of Example 35 to 36, wherein the set of rechargeable entities are autonomous electric tractors the set of objects are semi-trailers.

38. The computer program product of any one of Examples 35 to 37, wherein the RL agent is an attention based deep neural network.

39. The computer program product of any one of Examples 35 to 38, wherein the program instructions are readable by the processor to cause the processor to perform the operations of encoding the current state of the charging network to generate a set of node embeddings that are vector representations of the set of charging stations in the charging network, wherein executing, iteratively for each object among the set of objects, the decision making process comprises decoding a selection of a specific object using the set of node embeddings, decoding a selection of a specific rechargeable entity for the specific object based on the set of node embeddings and states of the set of rechargeable entities, decoding a selection of a specific charging station to be visited by the specific rechargeable entity based on states of the set of rechargeable entities and states of the set of objects, and applying a specific action that updates the state of the charging network, wherein the specific action is formed based on the specific object, the specific rechargeable entity and the specific charging station.

40. The computer program product of any one of Examples 35 to 39, wherein the sequence of actions is a 5-tuples representing a starting charging station, an ending charging station, a specific rechargeable entity, a specific object, and a decoding step of the iterative execution of the decision making process.

Various embodiments disclosed herein can be described by narrative text, flowcharts, block diagrams of computer systems and/or machine logic in computer program products. With respect to the flowcharts disclosed herein, depending upon the technology involved, the operations in the flowchart blocks can be performed in an arbitrary order, and two operations shown in successive flowchart blocks may be performed in reverse order, as a single integrated step, concurrently, or in a manner at least partially overlapping in time.

A computer program product embodiment disclosed herein is a term used for describing any set of one or more non-transitory computer-readable storage medium collectively included in a set of one or more storage devices that collectively include machine readable code corresponding to instructions and/or data for performing computer operations specified in the computer program products. A storage device is a tangible device that can retain and store instructions for use by a computer processor. A computer readable storage medium may be an electronic storage medium, a magnetic storage medium, an optical storage medium, an electromagnetic storage medium, a semiconductor storage medium, a mechanical storage medium, or any suitable combination of the foregoing. A computer readable storage medium, as disclosed herein, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media.

A computing device, as disclose herein, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database. A computing device may be located in a cloud. A processor, as disclosed herein, can include one or more computer processors of any type now known or to be developed in the future. A processor can implement multiple processor threads and/or multiple processor cores. Memory devices, such as caches, can be located in the processor and can be used for storing data or code that are available for rapid access by the processor. Computer readable program instructions can be loaded onto a computing device including one or more processors to cause a series of operational steps to be performed by the one or more processors and thereby effect a computer-implemented method, such that the instructions, when executed, will instantiate the methods specified in flowcharts and/or narrative descriptions of computer-implemented methods disclosed herein. The computer readable program instructions can be stored in various types of computer readable storage media. Computer readable program instructions for performing the operations disclosed herein can be downloaded to from one computing device to another computing device through a network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving input data indicating a current state of a charging network that includes a set of charging stations, a set of rechargeable entities and a set of objects with assigned destinations;
executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network;
determining a sequence of states of the charging network based on results from application of the sequence of actions, wherein the sequence of states represent transitions of the set of rechargeable entities and the set of objects to complete delivery of the set of objects to the assigned destinations; and
generating routing data to direct the set of rechargeable entities to navigate among the set of charging stations and to be coupled with the set of objects according to the sequence of states.

2. The computer-implemented method of claim 1, wherein:
the set of rechargeable entities include at least one of a non-autonomous electric tractor and an autonomous electric tractor; and
the set of objects include semi-trailers.

3. The computer-implemented method of claim 1, further comprising distributing the routing data to a plurality of processors of the set of rechargeable entities.

4. The computer-implemented method of claim 1, wherein the RL agent is an attention based deep neural network.

5. The computer-implemented method of claim 1, further comprising:
encoding the current state of the charging network to generate a set of node embeddings that are vector representations of the set of charging stations in the charging network,
wherein executing, iteratively for each object among the set of objects, the decision making process comprises:
decoding a selection of a specific object using the set of node embeddings;
decoding a selection of a specific rechargeable entity for the specific object based on the set of node embeddings and states of the set of rechargeable entities;
decoding a selection of a specific charging station to be visited by the specific rechargeable entity based on states of the set of rechargeable entities and states of the set of objects; and
applying a specific action that updates the state of the charging network, wherein the specific action is formed based on the specific object, the specific rechargeable entity and the specific charging station.

6. The computer-implemented method of claim 1, wherein each action among the sequence of actions is a 5-tuples representing a starting charging station, an ending charging station, a specific rechargeable entity, a specific object, and a decoding step of the iterative execution of the decision making process.

7. The computer-implemented method of claim 1, further comprising:
determining a cost associated with the sequence of actions, wherein the cost is based on:
a distance traveled by the set of rechargeable entities under the sequence of states;
a penalty that represents stagnation of the set of rechargeable entities; and
a reward that encourages selection of less-utilized rechargeable entities and minimize time for delivery of the set of objects; and
training the RL agent using the determined cost.

8. A system comprising:
a memory configured to store parameters representing a reinforcement learning (RL) agent;
a processor configured to:
receive input data indicating a current state of a charging network that includes a set of charging stations, a set of rechargeable entities and a set of objects with assigned destinations;
execute, iteratively for each object among the set of objects, a decision making process to model decision making by the RL agent, wherein the decision making process includes application of a sequence of actions on the charging network, and an application of each action among the sequence of actions changes a state of the charging network;
determine a sequence of states of the charging network based on results from application of the sequence of actions, wherein the sequence of states represent transitions of the set of rechargeable entities and the set of objects to complete delivery of the set of objects to the assigned destinations; and
generate routing data to direct the set of rechargeable entities to navigate among the set of charging stations and to be coupled with the set of objects according to the sequence of states.

9. The system of claim 8, wherein:
the set of rechargeable entities are electric tractors; and
the set of objects are semi-trailers.

10. The system of claim 8, wherein:
the set of rechargeable entities are autonomous electric tractors; and
the set of objects are semi-trailers.

11. The system of claim 8, wherein the RL agent is an attention based deep neural network.

12. The system of claim 8, wherein the processor is configured to:
encode the current state of the charging network to generate a set of node embeddings that are vector representations of the set of charging stations in the charging network, wherein iterative execution of the decision making process for each object among the set of objects comprises:
decode a selection of a specific object using the set of node embeddings;
decode a selection of a specific rechargeable entity for the specific object based on the set of node embeddings and states of the set of rechargeable entities;
decode a selection of a specific charging station to be visited by the specific rechargeable entity based on states of the set of rechargeable entities and states of the set of objects; and
apply a specific action that updates the state of the charging network, wherein the specific action is formed based on the specific object, the specific rechargeable entity and the specific charging station.

13. The system of claim 8, wherein each action among the sequence of actions is a 5-tuples representing a starting charging station, an ending charging station, a specific rechargeable entity, a specific object, and a decoding step of the iterative execution of the decision making process.

14. The system of claim 8, wherein the processor is configured to:
determine a cost associated with the sequence of actions, wherein the cost is based on:
a distance traveled by the set of rechargeable entities under the sequence of states;
a penalty that represents stagnation of the set of rechargeable entities; and
a reward that encourages selection of less-utilized rechargeable entities and minimize time for delivery of the set of objects; and
train the RL agent using the determined cost.

15. A computer-implemented method comprising:
receiving input data indicating a current state of a charging network that includes a set of charging stations, a set of rechargeable entities and a set of objects with assigned destinations;
executing, iteratively for each object among the set of objects, a decision making process to model decision making by a reinforcement learning (RL) agent, wherein the decision making includes application of a sequence of actions on the charging network, and an application of each action among the sequence of actions changes a state of the charging network;
determining a sequence of states of the charging network based on results from application of the sequence of actions, wherein the sequence of states represent transitions of the set of rechargeable entities and the set of objects to complete delivery of the set of objects to the assigned destinations;
determining a cost associated with the sequence of states, wherein the cost is based on at least one or more of:
a distance traveled by the set of rechargeable entities under the sequence of states;
a penalty that represents stagnation of the set of rechargeable entities; and
a reward that encourages selection of less-utilized rechargeable entities and minimize time for delivery of the set of objects; and
training the RL agent using the determined cost.

16. The computer-implemented method of claim 15, wherein:
the set of rechargeable entities are electric tractors; and
the set of objects are semi-trailers.

17. The computer-implemented method of claim 15, wherein:
the set of rechargeable entities are autonomous electric tractors; and
the set of objects are semi-trailers.

18. The computer-implemented method of claim 15, wherein the RL agent is an attention based deep neural network.

19. The computer-implemented method of claim 15, further comprising:
encoding the current state of the charging network to generate a set of node embeddings that are vector representations of the set of charging stations in the charging network, wherein executing, iteratively for each object among the set of objects, the decision making process comprises:
decoding a selection of a specific object using the set of node embeddings;
decoding a selection of a specific rechargeable entity for the specific object based on the set of node embeddings and states of the set of rechargeable entities;
decoding a selection of a specific charging station to be visited by the specific rechargeable entity based on states of the set of rechargeable entities and states of the set of objects; and
applying a specific action that updates the state of the charging network, wherein the specific action is formed based on the specific object, the specific rechargeable entity and the specific charging station.

20. The computer-implemented method of claim 15, wherein the sequence of actions is a 5-tuples representing a starting charging station, an ending charging station, a specific rechargeable entity, a specific object, and a decoding step of the iterative execution of the decision making process.
